(19) United States
(12) Patent Application Publication
(10) Pub. No.: US 2019/0080207 A1
(43) Pub. Date: Mar. 14, 2019

(54) DEEP NEURAL NETWORK VISUAL PRODUCT RECOGNITION SYSTEM

(71) Applicant: Frenzy Labs, Inc., Los Angeles, CA (US)

(72) Inventors: James Michael Chang, Los Angeles, CA (US); Sahil Shah, Los Angeles, CA (US); Megan Hardy, Los Angeles, CA (US); Jian Shi, Los Angeles, CA (US)

(73) Assignee: Frenzy Labs, Inc.

(21) Appl. No.: 16/028,401

(22) Filed: Jul. 5, 2018

Related U.S. Application Data
(60) Provisional application No. 62/528,988, filed on Jul. 6, 2017.

(51) Int. Cl. G06K 9/62; G06K 9/32; G06N 5/04; G06F 17/30

(52) U.S. Cl. CPC G06K 9/6267; G06F 17/30256; G06N 5/046; G06K 9/3241

(57) ABSTRACT

A classification apparatus is provided. The classification apparatus includes a reader apparatus configured to receive visual information and textual information associated with the visual information and detect query relevant categorization information regarding products or service of interest to a user from the visual information and textual information associated with the visual information, a localize and identify apparatus configured to receive the visual information and the query relevant categorization information and selectively reduce the visual information to a relevant visual representation and detect further categorization information based on the relevant visual representation, and a deep learning processor apparatus comprising a unit classifier and a type classifier, wherein the unit classifier correlates the relevant visual representation with a specific product identification code, and the type classifier correlates the relevant visual representation with a type considered represented in the relevant visual representation.

The present application claims the benefit of U.S. Provisional Patent Application Ser. No. 62/528,988, filed Jul. 6, 2017, inventors James Michael Chang, et al., entitled “Automated Visual Product Recognition System to Establish a Deep Convolutional Neural Network with Brand and SKU Classifiers,” the entirety of which is incorporated herein by reference.

### BACKGROUND OF THE INVENTION

### Field of the Invention

The present invention generally relates to computerized recognition systems, and more specifically to automated visual product recognition systems used with deep convolutional neural networks.

### Description of the Related Art

The ability for a machine or computing device to associate an image with an item in the image and direct a user to a relevant site represents a complex image recognition, artificial intelligence, computer science, and potentially neural network problem. In short, how can a user look at a picture on a computing device, with no information about an item in the image, and obtain information and/or acquire the item simply and rapidly? While this problem is prevalent in many areas wherein images are employed, it will be discussed herein with particular emphasis on clothing, or in other words solving the following problem: What is the fashion item in that online picture, and how can I get the same fashion item?

In the fashion or clothing situation, with the rapid growth of images being shared on social networks and fashion blogging, a need for devices and tools to identify specific products such as clothing displayed in images arises. Web site owners are capitalizing on the influential nature of their offerings by providing consumers with URLs useful to purchase products discovered on social networking sites, shopping sites, blogs, and the like. Current product recognition solutions utilize computer vision APIs and object recognition systems that are unable to identify products with a significant degree of accuracy, and fail to offer a scalable method enabling publishers to use images to promote product sales. Existing offerings in this area require a great deal of human interaction, which is undesirable, such as people reviewing photos, tagging photos, associating photos with products available for sale, etc. Site owners and bloggers can spend up to several days making efforts to monetize images: identifying products within images, data mining product URLs, managing payment programs, and updating expired URLs resulting from a given product being out of stock or otherwise unavailable, such as an offering expiring after a certain amount of time.

Known product recognition solutions employ tactics such as cosine similarity and clustering methods which enables a search for the “nearest” product results or for visually “similar” products. Some systems use general image classifier models to generate a text description or label of the object(s) of interest within the contents of an image, e.g. “woman in red shirt.” Text output is typically trimmed to include only the product attributes, i.e. ‘red shirt,’ and the system can initiate a search engine query and filter to display merchant results. Many product attributes remain unseen by existing computer vision systems and thus unusable or unworkable, resulting in difficulties determining whether the woman subject in the image is wearing a particular shirt. Systems without brand classification capability or the inability to recognize relevant additional product attributes (i.e. “buttons, ruffles, pleats”) can achieve less than 10% accuracy when analyzing, for example, the top five product results generated by such systems.

Recently, a key trend in fashion blogging and fashion images shared on social media has bloggers and publishers labeling or tagging brands or general types of information corresponding to branded products or types of items seen in a given image. Lacking an automated solution, users are forced to take note of information such as brand labels and visual characteristics of products seen in the image. Then, using attributes manually culled from the image and possibly associated text, the user must conduct a manual query using search engines to determine the exact brand and SKU of a product or products seen in the subject image. This process is highly inefficient, time consuming and accuracy of the result relies solely on the expertise of the user.

In short, the user may visit a web site or blog and see a celebrity wearing a particular piece of clothing or accessory. The user may have no way of knowing where she may purchase a similar piece of clothing or accessory, and may be forced to look at images, decide whether the item is one offered by a particular entity, and then shop for the item online. Even then, her sleuthing capabilities may have been incorrect and she may be unable to purchase the desired item, may visit an inapplicable web site, or may purchase the wrong item. All of this is undesirable, and in the more broad, non-fashion specific context: the ability for the user to see a picture online and quickly and efficiently connect to a shopping site where she can immediately purchase the item represents a computer science, artificial intelligence, and/or computational problem that to date has been unsolved.

Thus, there is a need for an artificial intelligence or neural network that overcomes problems with the previous systems and combines the ability to extract attributes of products in a scene or image that were previously unseen to current computer vision systems, including attributes such as “blouse, silk, red, buttons, ruffles, pleats” in order to and accurately classify products seen in media.

### SUMMARY OF THE INVENTION

Thus, according to one aspect of the present design, there is provided a classification apparatus, comprising a reader apparatus configured to receive visual information and textual information associated with the visual information and detect query relevant categorization information regarding products or service of interest to a user from the visual information and textual information associated with the visual information, a localize and identify apparatus configured to receive the visual information and the query relevant categorization information and selectively reduce the visual information to a relevant visual representation and detect further categorization information based on the relevant visual representation, and a deep learning processor apparatus comprising a unit classifier and a type classifier, wherein the unit classifier correlates the relevant visual representation with a specific product identification code, and the type classifier correlates the relevant visual representation with a type considered represented in the relevant visual representation.

According to a further aspect of the present design, there is provided a method for classifying items using a classification apparatus. The method comprises receiving visual information and textual information associated with the visual information, detecting query relevant categorization information regarding products or service of interest to a user from the visual information and textual information associated with the visual information, receiving the visual information and the query relevant categorization information and selectively reduce the visual information to a relevant visual representation, detecting further categorization information based on the relevant visual representation, correlating the relevant visual representation with a specific product identification code, and correlating the relevant visual representation with a type considered represented in the relevant visual representation.

According to another aspect of the current design, there is provided a classification apparatus comprising reader means for reading information provided, wherein the reader means are configured to receive visual information and textual information associated with the visual information and detect query relevant categorization information regarding products or service of interest to a user from the visual information and textual information associated with the visual information, localize and identify means for visually identifying information, wherein the localize and identify means are configured to receive the visual information and the query relevant categorization information and selectively reduce the visual information to a relevant visual representation and detect further categorization information based on the relevant visual representation, and deep learning processor means for establishing additional information related to the visual information, wherein the deep learning processor means are configured to correlate the relevant visual representation with a specific product identification code and correlate the relevant visual representation with a type considered represented in the relevant visual representation.

These and other advantages of the present invention will become apparent to those skilled in the art from the following detailed description of the invention and the accompanying drawings.

### BRIEF DESCRIPTION OF THE DRAWINGS

For a more complete understanding of the present disclosure, reference is now made to the following figures, wherein like reference numbers refer to similar items throughout the figures:

FIG. 1 is a data flow diagram that illustrates the flow of an automated visual product recognition system according to the present invention;

FIG. 2 is a component diagram of components included in a typical implementation of the system in context of a typical operating environment;

FIG. 3A is a first part of a flow chart illustrating the relationship between the Read and Listen and Information Retrieval modules;

FIG. 3B is a second part of a flow chart illustrating the relationship between the Read and Listen and Information Retrieval modules

FIG. 4 is an illustration of an example semantic network according to Read & Listen Module;

FIG. 5A is diagram showing a first proximity assessment showing the narrowing down of parts of speech using contextual analysis executed by the Read and Listen module;

FIG. 5B is diagram showing a second proximity assessment showing the narrowing down of parts of speech using contextual analysis executed by the Read and Listen module;

FIG. 5C is diagram showing a third proximity assessment showing the narrowing down of parts of speech using contextual analysis executed by the Read and Listen module;

FIG. 6 is a data flow diagram that illustrates the flow of information in the ‘Localize’ module;

FIG. 7 illustrates an aspect of the Product Classifier Module for searching a finite image collection to determine the input image is related and assign a score;

FIG. 8 illustrates another aspect of the Product Classifier Module for searching a finite image collection to determine if the input image is related and assign a score;

FIG. 9A is a first part of a data flow diagram that illustrates the flow of information and the relationship between Localize and Product Classifier Modules;

FIG. 9B is a second part of a data flow diagram that illustrates the flow of information and the relationship between Localize and Product Classifier Modules;

FIG. 10A is a first part of a flowchart that illustrates the method and steps performed by the Localize and Product Classifier modules to identify products seen in media;

FIG. 10B is a second part of a flowchart that illustrates the method and steps performed by the Localize and Product Classifier modules to identify products seen in media;

FIG. 11A is a first part of a flowchart that illustrates the steps performed by the automated visual product recognition system according to the present design;

FIG. 11B is a second part of a flowchart that illustrates the steps performed by the automated visual product recognition system according to the present design; and

FIG. 12 is an overall representation of the novel system presented herein.

The exemplification set out herein illustrates particular embodiments, and such exemplification is not intended to be construed as limiting in any manner.

### DETAILED DESCRIPTION OF THE INVENTION

The present invention is in the technical field of computerized object recognition systems, and more specifically, to an automated visual product recognition system and method that can identify exact type (e.g. brand) and SKU of the product(s) displayed in the image or video; determine the retail establishments or online presence where these product(s) are sold or items can be found and provide a direct path or URL to transaction; and train image classification models to establish a deep neural network for specific items, including but not limited to branded products. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structure and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise each feature disclosed is one example of only of a generic series of equivalent or similar purpose, unless expressly stated otherwise. Thus, unless expressly stated otherwise, each feature disclosed is one example only of a generic series of equivalent or similar features.

In general, the present design comprises a neural network method and system to achieve automated visual image recognition. The system includes an Information Retrieval Module, Read and Listen Module, Localize Module, Product Classifier Module, Learning Module and a Neural Net.

The artificial intelligence/neural network system is a hardware implementation operating in a particular manner using unique functionality to make determinations and perform computer science tasks previously not available. In short, the present design solves a technical computer science/artificial intelligence problem of matching items in images with the actual item itself, with the possibility of connecting a user to a desired item located within a picture and minimal or no information available about the item other than its representation in the image. Such computer science/artificial intelligence/neural network operation has been previously unattainable.

The Information Retrieval Module is configured to parse images, text, audio and video provided by the associated user or from a network. The Information Retrieval Module is also configured to format and transcribe audio into a readable text format. The Information Retrieval Module processes text into a universal format to undergo further processing by the Read and Listen Module. The Information Retrieval Module is configured to dissect video into image frames that can be analyzed and undergo further processing by Localize and Product Classifier Modules.

The Read and Listen Module is configured, in the clothing/fashion scenario, to identify clothing and brand related keywords contained in text or transcribed audio. The Read and Listen Module is also configured to use contextual analysis to discern various brands and product attributes described in the text in the clothing situation. Brand or type keywords may be extracted and paired with product attribute keywords based on a proximity score. In another aspect, the Read and Listen Module is configured to submit queries to the Information Retrieval Module after pairing related brands and product attribute keywords detected.

The Information Retrieval Module may be further configured to parse product data from third parties, in the clothing situation retailers and merchants, corresponding to brand and product attribute keyword pair received from the Read and Listen Module. Product data or other relevant data may be indexed according to, for example, brand, name, color, category, material, price and stock availability. The Information Retrieval Module is also configured to receive images and media related to a clothing product, for example. The Information Retrieval Module may convert images and video into usable media for the Localize Module, Product Classifier Module, Learning Module, and Neural Net.

The Localize Module is configured to detect and isolate objects of interest within an image. The Localize Module also defines a bounded region in which the object is located, the bounded region being the sub-portion of the entire portion of the image. The Localize Module may extract the object of interest from the image by cropping or separating the bounded region or sub-portion of the entire portion of the image where the object exists.

The Product Classifier Module is an optional module, specific to products such as fashion products, that includes of a brand classifier configured to identify the type or brand, designer label or manufacturer of the fashion item, and a SKU classifier which is configured to identify the characteristics, features and attributes of the object provided by the Localize Module. The Product Classifier Module receives the extracted object and feature vectors within the bounded region or sub-portion of the entire image and associate a text label to classify the object. The Product Classifier Module is also configured to generate a confidence value reflective of an accuracy of the classification of the object. The Product Classifier Module may score and rank products from a given product data set, parsed from a third party (such as a third party retailer) by the Information Retrieval Module, corresponding to the text label associated with the object. The Product Classifier Module can enable users to indicate whether items in the queried data set are an exact match to objects seen in the image and can assign a higher score to the associated item.

As noted, the present design is general in nature and represents a system and method that seeks to achieve automated visual image recognition. While described herein primarily with respect to fashion, clothing, and brands, the design is not so limited. In this instance, the Product Classifier described above, when offered, operates irrespective of the type of product. For example, a general Classifier may be provided that identifies attributes of the image selected, receiving extracted object and feature vectors within a bounded region or sub-portion of the entire image and associate a text label to classify the object. Such a Classifier may generate a confidence value reflective of an accuracy of the classification of the object, using knowledge of prior images to determine a confidence level, i.e. the item in this image represents a tulip with a level of confidence of 92%. Additionally or alternately, the user may be prompted to identify the object of interest—this is a “Michelin tire” or a “kangaroo” and the system uses that information to classify and provide further functionality on this basis. Such a Classifier or Classifier Module may score and rank items from a given product data set, parsed from a third party by the Information Retrieval Module. Such a Classifier Module can enable users to indicate whether items in the queried data set are an exact match to objects visible in the image and can assign a higher score to the associated item.

Additionally, the Learning Module may train and store extracted objects in the associated image collection corresponding with an identifier, such as an appropriate SKU classifier in the clothing/fashion situation, if the assessed confidence value meets or exceeds a predetermined threshold. The Learning Module may train and store extracted objects in an image collection corresponding to an appropriate type or brand classifier (e.g. Goodyear tires, Luxottica sunglasses, Kellogg cereals, Michael Kors blouses) if the confidence value meets or exceeds a predetermined threshold. The system may also include a training function that stores extracted objects in image collections, where the image collections pertain to brand and/or SKU type classifiers and may also or alternately train and add new brand and/or SKU type classifiers to the data set.

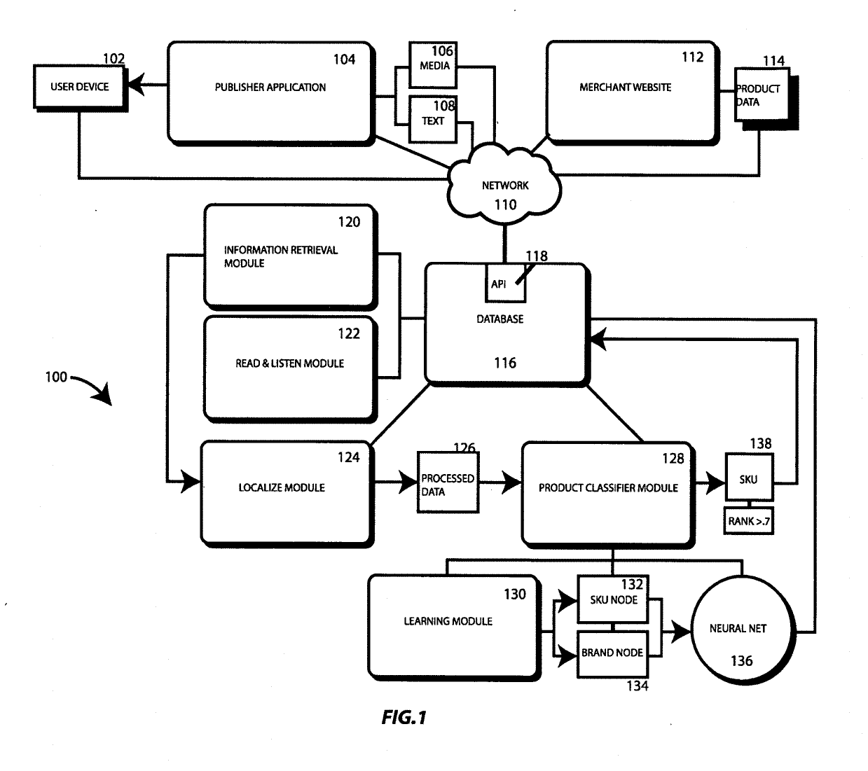

FIG. 1. is a data flow diagram depicting the data flow for a automated visual product recognition system 100. In the illustrated embodiment, automated visual product recognition system 100 includes an information retrieval module 120, read and listen module 122, localize module 124, product classifier module 128 learning module 128 and database 114.

The information retrieval module 120 communicates with publisher application 104 to receive media 106 including images, video, and/or text 108 via network 110. As used herein, the term “network” may include, but is not limited to, a Local Area Network (LAN), a Metropolitan Area Network (MAN), a Wide Area Network (WAN), the Internet, or combinations thereof. Embodiments of the present design can be practiced with a wireless network, a hard-wired network, or any combination thereof.

In response to the signal received from the publisher application 104, the automated visual product recognition system 100 uses the read and listen module 122 to process text 108 and extract fashion related keywords that usually consist of, in the case of fashion, brands, designer labels and language describing relevant items, such as clothing, visible in the scenes of images or video (media 106). Such text 108 sources may include media captions, image labels, image tags, article text, header text, border text, user comments, text messages, text displayed in an image or video, subtitles, hidden text, and is not limited to any type of audio transcription output, printed text or digital text. Simply put, any identifiers associated with the image are assessed for known or identifiable textual information in the realm of interest. For example, an image containing electronic equipment where electronic equipment is of interest may result in a search of the aforementioned textual information for brand names such as Apple, Samsung, Qualcomm, LG, Asus, Motorola, Google, etc., and/or item names such as processor, hard drive, camera, smartphone, and so forth, and even specialty text such as RAM, GB, i8, S7, specific to the items in question.

Read and listen module 122 uses contextual analysis 320 to pair keywords, such as branding related keywords, and language describing products seen in the image. A query may be constructed using the brand and product keyword pair i.e. ‘[brand/designer] blouse’ and the system transmits the query to information retrieval module 120. Information retrieval module 120 parses product data 114 from, for example, a seller's website 112 and stores the parsed product data in the system's database 116 for indexing. Product data 114 may include one or more images associated with each product, name, brand, description, details, color, and in the case of clothing, material, sizes, stock availability, price and any relevant store or retailer where, for example, the product can be purchased. Products in the data set are ranked according to number of matching attributes i.e. ‘silk, red, buttons, ruffles, pleats” is ranked higher than ‘buttons, ruffles, pleats’ for a shirt detected by read and listen module 122.

In another embodiment, localize module 124 employs an object detection algorithm to isolate a product or products in the image and generate a respective bounded region or regions. A bounded region or sub region of the image may then be cropped for each respective product of interest in the image. Processed data 126 or cropped images of relevant products are transmitted to product classifier module 128 for classification.

In another embodiment, product classifier module 128 components work together to form an image classification system with specific configurations for identifying products. Components include but are not limited to convolutional layer, activation layer, pooling layer, fully connected layer and image collections. At the convolutional layer, product classifier module 128 generates feature maps or vectors for attributes i.e. in the case of clothing, ‘ruffles, buttons, pleats’ for products found in the scene that have in the past been less obvious to traditional image classification systems. The activation layer generates vector maps for features that are even less obvious, such as ‘exposed clothing tag,’ to detect product attributes of interest that the convolutional layer may have missed. The pooling layer may employ a pooling process to filter each vector into a condensed version so that only best versions of attributes, i.e. ‘ruffles, buttons, pleats’ are featured. Best in this context may take different forms depending on preference, including but not limited to best being the attributes likely to match the most popular or most readily identifiable product features, or the attributes having a highest rating, i.e. a highest level of confidence, or conversely discarding or providing a low rating for least noteworthy attributes or attributes where the system has the lowest certainty. For example, if buttons are readily identifiable but only one button is shown and the button is in an odd place on a piece of clothing and is decorative rather than functional, the “button” attribute may be pooled at a low level or value when assembling a condensed version of the attributes.

At the fully connected layer, pooled feature maps connect to learning module 103 and output nodes may initiate voting on each feature map. In other words, in this situation, image collections may include thousands to potentially billions of items of processed data 126 or cropped images of products, indexed with respect to their highest scoring attributes. Products in the scene display in many variations with respect to lighting, angles, against different skin tone pigments, and scenery. The system trains data, and as a result of the training, new product attribute classes are established and the data set increases. Two hundred different views of steering wheel X from different angles in different lighting serves to more accurately determine whether this unknown steering wheel is steering wheel X. Training in this way, with exposure to products in different contexts in multiple different images, improves the system's ability to accurately classify a brand-specific product in the image.

Processed data 126 or cropped images of products are transmitted to product classifier module 128. Product classifier module 128 receives processed data 126 and fully connected layer may “vote” on the feature maps of products, positive or negative. The final output of product classifier module 128 may be expressed as a percentage and uses a probabilistic approach to classify processed data 126. The system generates a text label for each cropped image corresponding to its highest scored attributes i.e. ‘brand/designer, blouse, silk, red, ruffles, pleats, buttons, tie.’

Products stored in the database 116 remain in queue while the product classifier module 128 works through and completes the preceding operations. Products in the queue may be ranked according to number of product attributes and/or the strength of product attributes, for example in the clothing realm, ‘brand/designer, silk, red, buttons, ruffles, pleats’ matching the image classification label. Attributes may be matched according to, in the clothing example, product's brand/designer, category, name, description, color, and material. The highest ranked products remain in the data set while lower ranked products are ignored or deleted.

In one embodiment, the highest ranking products in the data set are SKU numbers, or SKUs 138. API 118 transmits SKUs 138 in the data set through a network 110 to publisher application 104 in the form of JSON or XML data. SKU 138 data transmitted from API 118 may be reconstructed or reproduced in a widget, product list, or image tag and may be, for example, displayed near or on top of media 106 contained in publisher application 104. Reconstructed SKUs may be displayed via the user device 102 with options to buy or view more information about a SKU 138 corresponding to media 106 (image or video) in view from publisher application 104.

In another embodiment, learning module 103 uses deep learning methods to train new classifiers and reinforce existing classifiers. Processed data 126 or cropped images receiving a score that meets or exceeds a predetermined threshold are employed in training and stored in the corresponding image collection for a particular attribute class. Image collections for each class may be organized at either SKU node 132 or brand or type node 134 where brand or type node 134 contains brand/designer information in classes and SKU node 132 includes only product attribute information in classes. Brand node 134 would include all Apple iPhone product information in classes, for example. If processed data 126 is below a predetermined threshold at a given product attribute class level, indicating not enough data is available for the product attribute class, learning module 103 creates a new classifier by pairing attributes where the score meets or exceeds a predetermined threshold at the category class level 402. Highest scoring attributes are paired together to establish a new class. In operation, this works as follows: only three tags are available for Smith brand food products—cereal, oatmeal, and yogurt, but scores of images are available within the system, indicating differences between the various product classes exist. Learning module 103 creates further tags where a certain threshold is exceeded, such as corn cereal versus rice cereal, brown sugar oatmeal and apples and cinnamon oatmeal, etc., or even taking differences apparent from the products, such as blue box versus red box. Any product class identifier may be created, and such further classification may be provided when the number of images is high in a given category relative to the categories. However, this may be context dependent; if, for example, Nokia only offers two types of phones for sale, the fact that the system has 10,000 photos of the two Nokia phones available to consumers may not necessitate creation of further classifiers at the category class level. The system thus monitors the need for operating with this functionality and once new categories or classifiers are created, goes back through existing known images and classifies those images according to the new classifier(s).

Neural Net 136 includes image collections from brand or type node 134 and SKU node 132, a convolutional layer, an activation layer, a pooling layer, a fully connected layer and embodies all processes performed by both output nodes.

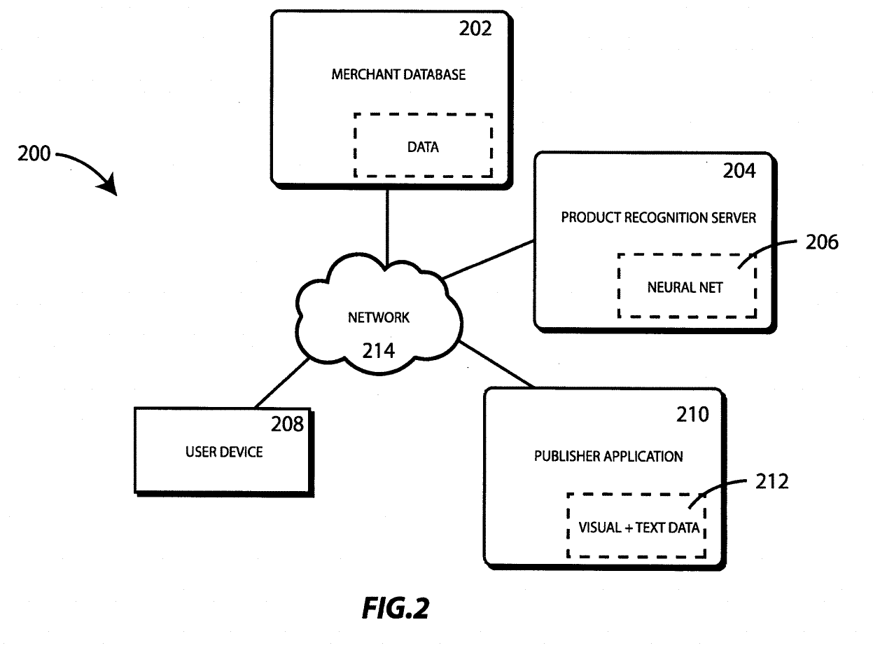

FIG. 2 is a component diagram showing the various embodiments required of the automated visual product recognition system 200. The system may include a network 214, user device 208, merchant database 202, product recognition server 204 with neural network 206 and publisher application 210 with visual and text data 212. Product recognition server 204 communicates through network 214 and receives visual and text data 212 from publisher application 208. Product recognition server 204 constructs a query using text or audio data 212 and transmits a request through a network 214 to merchant database 202. For example, a text query may include “Hankook|all weather|17 inch inner diameter.” Based on the text generated, product recognition server 204 may receive product data from merchant database 202. Neural network 206 takes visual data, such as photographic representations of products, and classifies type-specific products in the visual data 212 received from the publisher application, such as visual representations of Hankook tires. In the final output, product data is ranked according to number of attributes matched from a visual classification result. From the previous example, a database may include 1243 visual representations of 17 inch inner diameter Hankook all weather tires.

Product data may be compiled in an appropriate format, such as JSON or XML format, and transmitted from product recognition server 204 through a network 214 to be displayed in publisher application 210. Publisher application 210 displays media and corresponding product data through a network 214 and transmits to a user device 208.

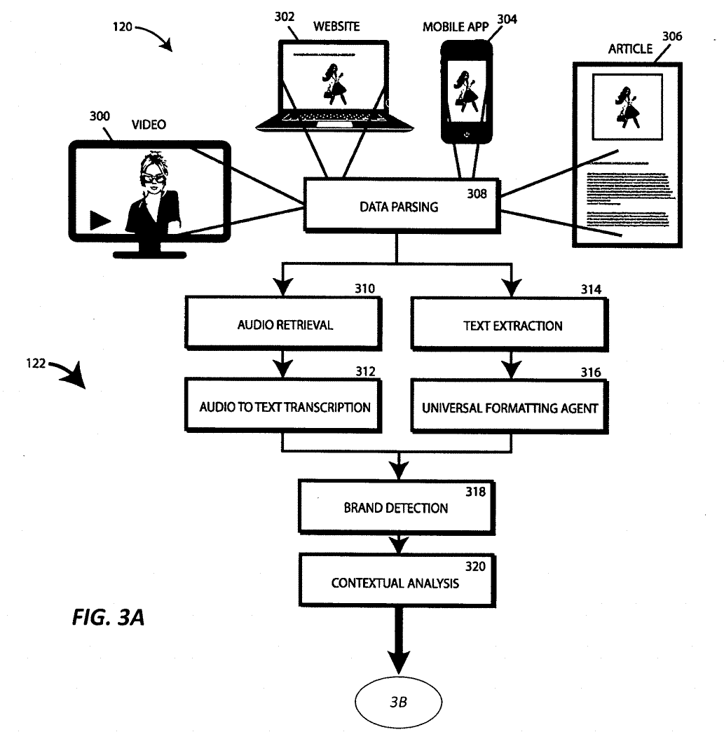

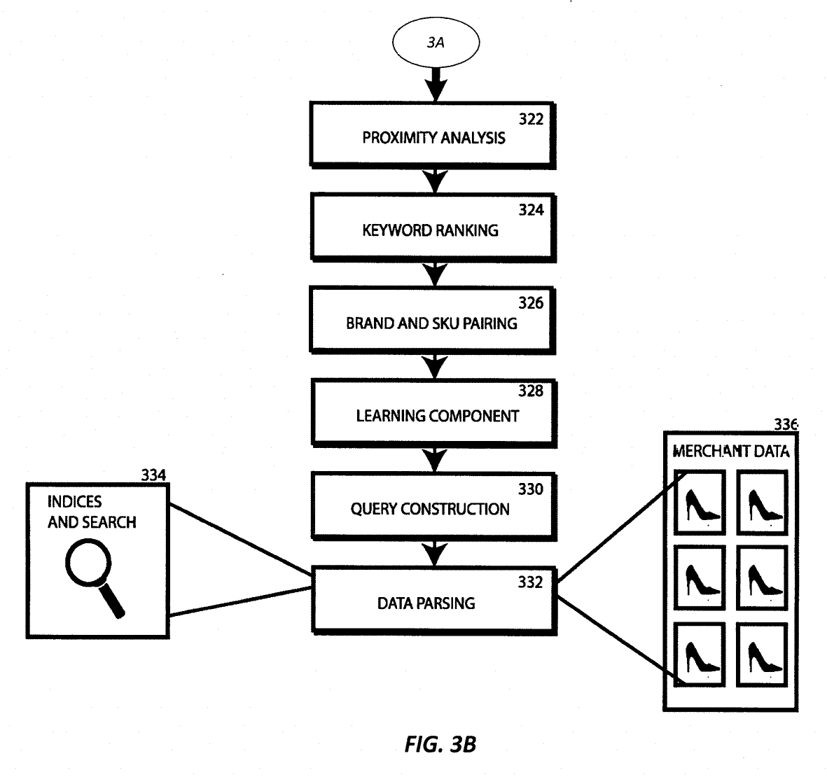

FIGS. 3A and 3B represent a flow chart generally illustrating operations performed by read and listen module 122 and information retrieval module 120. Data parsing 308 by information retrieval module 120 captures visual and text or audio data from various embodiments including but not limited to video 300, website 302, mobile application 304, digital and print articles 306 Images are received and processed into readable formats to undergo further processing and classification by product classifier module 128. Videos may be processed into image frames to undergo further processing and classification by product classifier module 128. Audio retrieval module 310 captures, extracts and records sound originating from data received so that in proper circumstances a separate audio file can be established. The final output of audio retrieval module 310 is a digital audio file in the form of, for example, MP3, AAC, Apple Lossless, AIFF, Way, CD Audio, and Movie Audio, or other appropriate format. Audio to text transcription 312 may transcribe auditory natural language into digital text format. If a language other than English is detected, a translation tool adapts text into English language text. Text extraction processing module 314 captures and extracts text originating from but not limited to various embodiments listed above. Such text sources may include media captions, image labels, image tags, article text, header text, border text, user comments, text messages, text displayed in a image or video, subtitles, hidden text and is not limited to any type of audio transcription output, printed text or digital text.

Universal formatting agent 316 may convert captured text into a standardized format for further analysis. Universal formatting agent 316 may format web or computer based text and erase non-relevant html tags, javascript variables, breaks and special characters or symbols, and so forth from the desired output. Brand (or type) detection module 318 detects and extracts relevant brand, designer, maker or manufacturer keywords within formatted text, searching a index of all known brands, manufacturers and designer in a database 116. Contextual analysis 320 extracts relevant product attribute keywords that describe products in the accompanying scene. Product attribute keywords include but are not limited to category, name, description, and in the case of fashion, color, material, price and retailer information. Other attribute keywords may be employed.

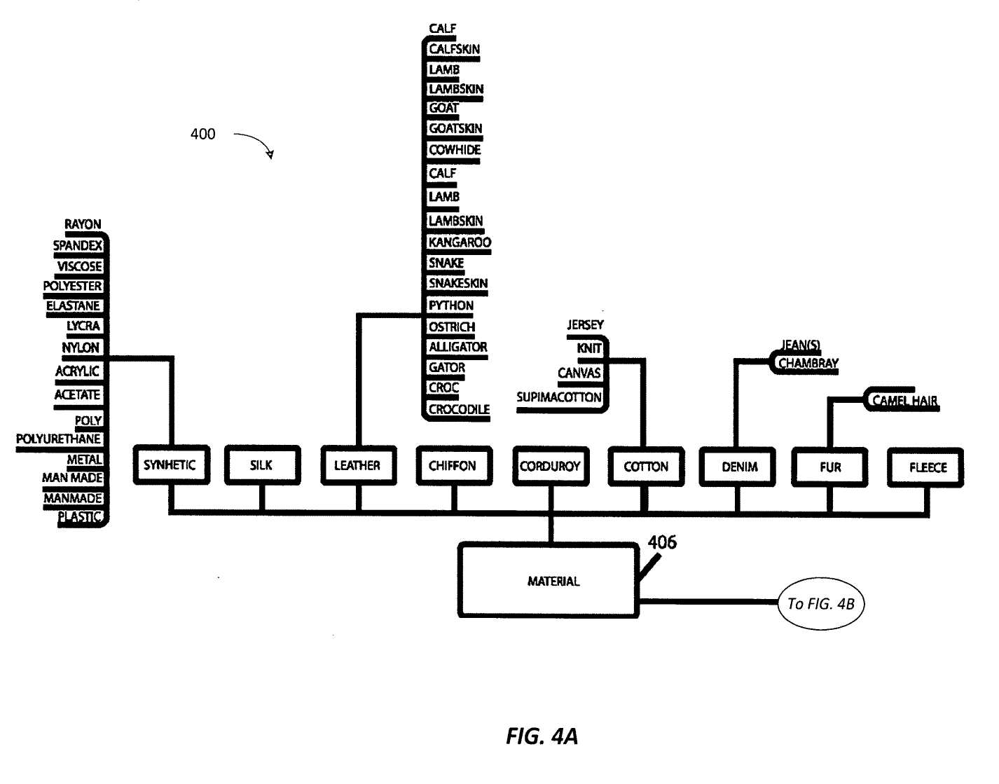

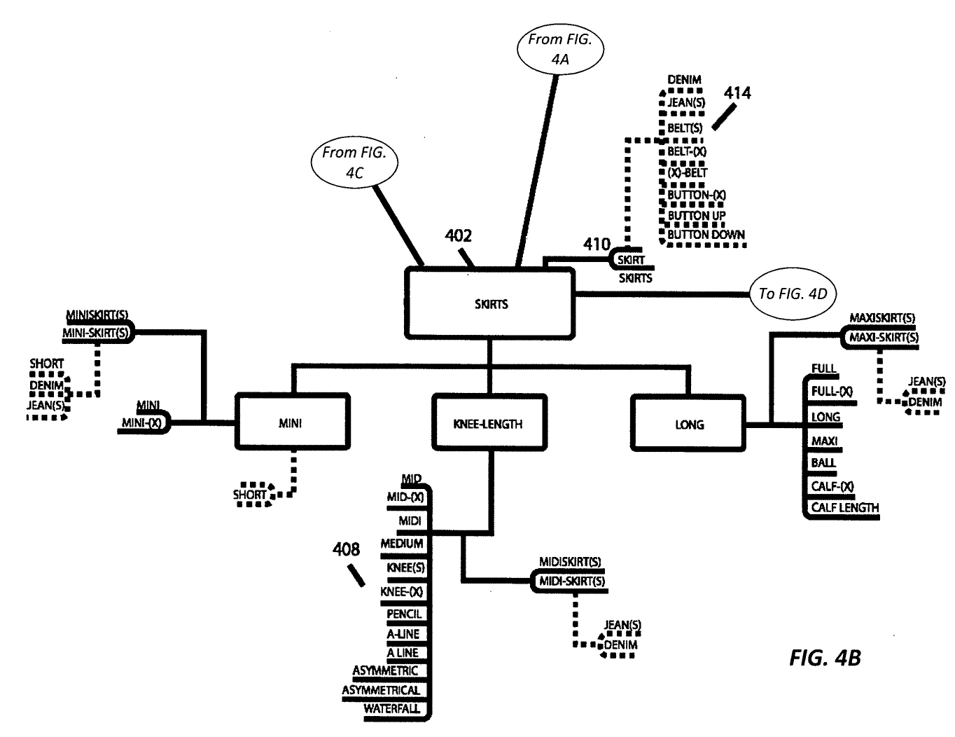

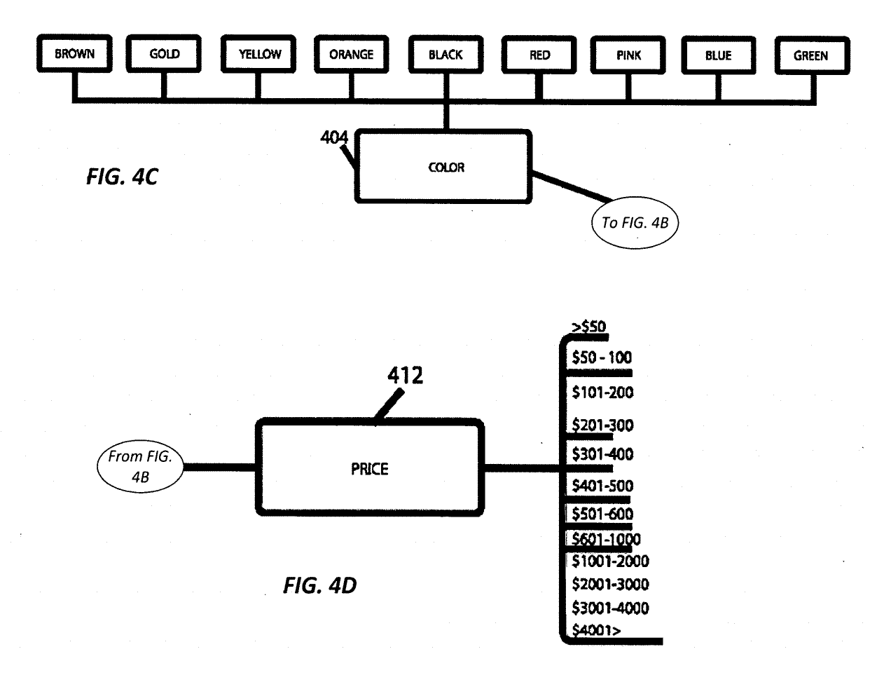

Hardware and functionality relating to rule sets and operations employed to determine if processed text contains product attribute keywords is shown by language dictionary module 400 illustrated in FIG. 4. Proximity analysis 322 calculates distance between product attribute keywords to and from brand or type keywords. Keyword ranking module 324 assigns a score to each product attribute keyword based on its proximity to and from a brand keyword. Proximity analysis and keyword ranking may determine how far, in a numerical value, certain words or concepts are from one another. For example, using the word “clothing,” a word like “shirt” might have a value of 1.0, while words like “sunglasses” or “wristwatch” may have a lower value, such as 0.50. Words like “fish” or “potato” may have a distance from “clothing” of zero. As may be appreciated, distance may be the opposite, where something that conforms to the word has a distance of zero, and something remote has a value of 1.0 (or some other scale/number value). Brand and SKU pairing 326 is configured to pair product attribute keywords and brand keywords with highest proximity scores. For example, Apple may be paired with “iphone” “Macintosh” “Mac” and so forth, but not “shirt” or “tire” or “fruit.” In this situation, a shirt with an Apple logo may need to be analyzed in greater depth, and there may be some overlap such that keywords are employed to varying degrees. Such additional analysis and processing may be at least partially addressed by learning component 328, which analyzes historical data of brand/type and product attribute keyword pairs to find patterns. Learning component 328 may change brand and product attribute keyword pairs, or detect new brand/type and product attribute keyword pairs, and may add or decrease weight to brand/type and product attribute keyword proximity scores.

During operation, information retrieval module 120 receives brand/type and product attribute keyword pairs from read and listen module 122. For example, the word “Heinz” and “ketchup” may be a brand-product attribute keyword pair. Query construction 330 constructs a query using brand/type and product attribute keyword pairs from read and listen module 122. A query may be produced that includes, for example, “Heinz” and “mustard,” seeking to identify all Heinz mustard items available, and multiple such pairings may be employed if desired, such as “Apple 2016 iphone7 used” The query is transmitted through a network by information retrieval module 120. Data parsing module 332 extracts merchant data 336 and product data from indices using search engines 334. Product data retrieved is indexed in a database according to, for example, brand/type, name, category, description, details, color, material, sizes, stock availability and price. For example, Heinz may sell eight different variations of mustard products, broken by container size and type, number of products packaged together, and type (yellow mustard, brown mustard, mustard mixed with hot sauce, etc.)

FIG. 4 represents language dictionaries 400 utilized for contextual analysis 320 embodied in read and listen module 122. Contextual analysis comprises semantic tables and dictionaries containing keywords stored in a database 116 which are configured to assign various product attributes based on keywords detected within text. The clothing situation is reflected in FIG. 4, and in the clothing situation, product attributes may include but are not limited to name, category 402, color 404, description, details, material 406, price 412 and retailer. Contextual analysis 400 assigns, in the case of clothing, a product category, color, description, material, price and retailer based on absolute keywords, keyword pairs, absolute keyword pairs, and special language cases detected from input text.

Absolute keywords 410 detected from input text yield a corresponding product attribute 402. An absolute keyword represents an identical word concept, or words deemed to be synonymous, such as “boat” and “ship.” A keyword for pairing 408 must exist alongside absolute keywords 410 within input text to yield a product attribute 402. Keyword pairs are not restricted to specific order, therefore a keyword for pairing 408 may appear before an absolute keyword 410 or vice versa, existing with or without non-qualified keywords in between. A non-qualified keyword is a keyword absent from a language dictionary 400. Absolute keyword pairs are restricted to a specific ordering such that they can be interpreted within the system. In the present design, a keyword for pairing 408 appears before or after an absolute keyword 410 without interference from, or presence of, non-qualified keywords in order to assign a product attribute 402. Other ordering may be employed, but the overall desire is a system that can utilize the pairings effectively and efficiently according to a uniform naming and content convention for information transmitted. Special language cases occur when an absolute keyword 414 corresponding to a product attribute exists alongside an absolute keyword corresponding to a different product attribute 402, in any order with or without non-qualified keywords in between. Language dictionary 400 omits product attributes corresponding to one absolute keyword 414 ‘denim, jean, belt’ in favor of product category corresponding to another absolute keyword 410 based on a computational rule set. In this case example, language dictionary 400 may provide ‘skirt’ product category 402, with ‘jeans,’ ‘belts,’ and ‘shirt’ 414 product categories omitted.

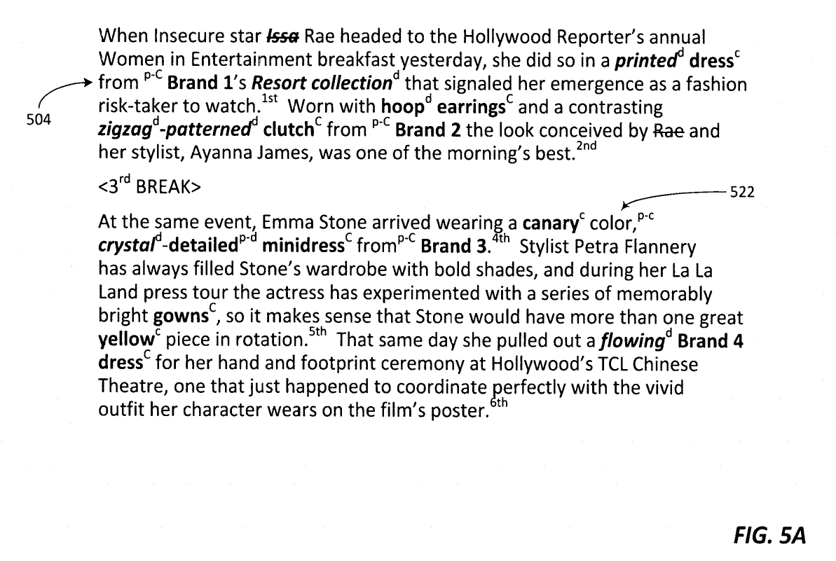

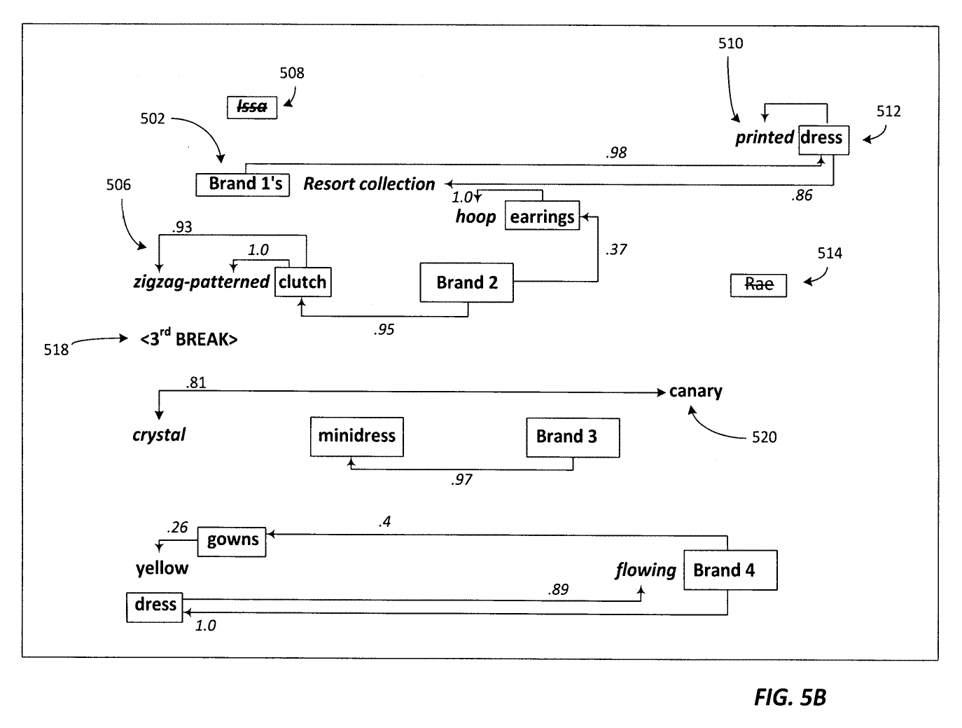

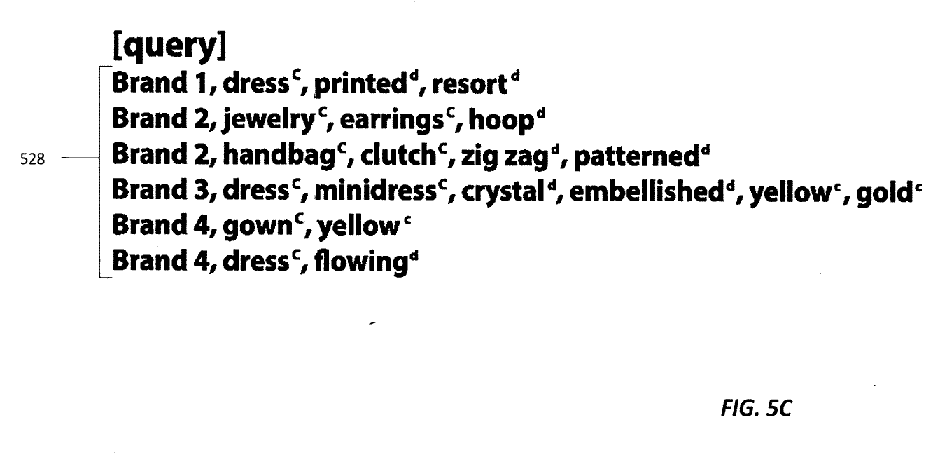

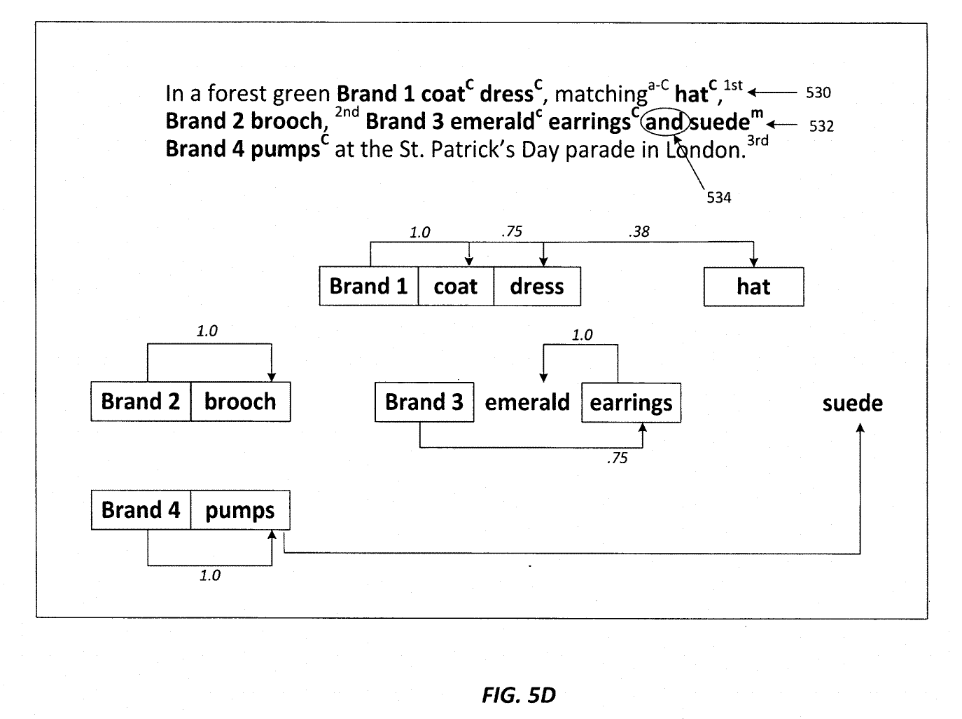

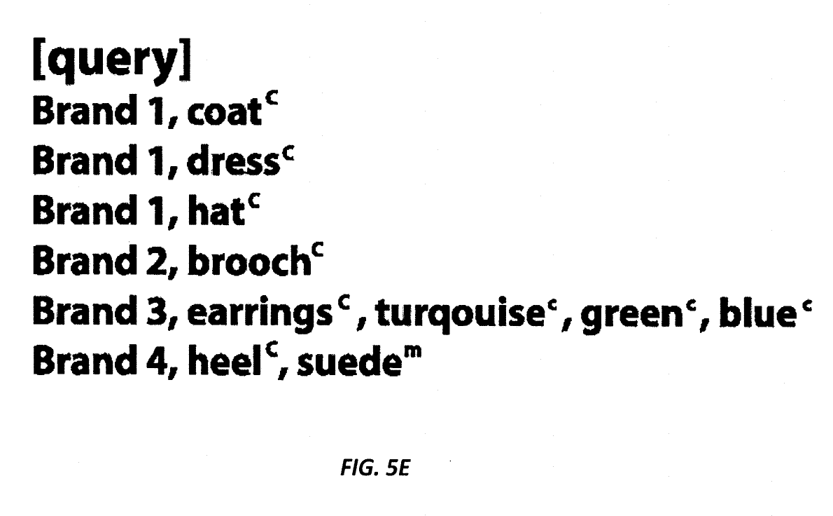

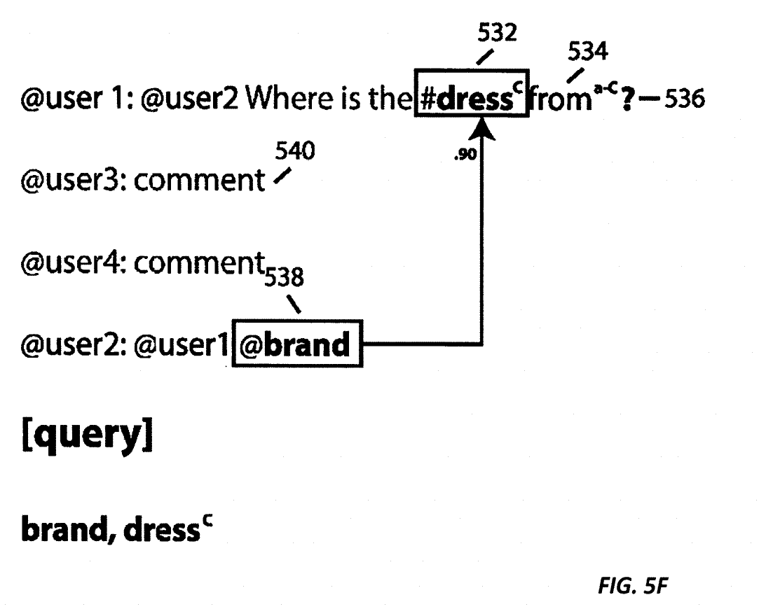

FIGS. 5A, 5B, and 5C illustrates general operation of brand/type detection module 318, contextual analysis module 320, proximity analysis module 322, keyword ranking module 324, brand/type and SKU pairing module 326, learning component 328, and query construction module 330 embodied in read and listen module 122. FIGS. 5A, 5B, and 5C also illustrate internal processes for data parsing 332 embodied in information retrieval module 120. Brand/type detection module 318 in the clothing context is configured to identify relevant brand/type, manufacturer, and designer related keywords from received input text. The system uses a dictionary to detect brand/type keywords 502 and/or may employ an index of all known brands, manufacturers, and designers using a database. Contextual analysis module 320 identifies product attribute keywords from input text using a language dictionary 400. Product attribute keywords in the clothing realm may include but are not limited to product category, name, description, details, color, material, price and retailer, shown as elements 510, 512, 520, and 532 in FIGS. 5A, 5B, and 5C.

In FIG. 5A, a first proximity assessment is shown, representing actual text in an online post, which may be a blog post, marketing type post, social media post, or otherwise. In the text are various words brand names, punctuation, and so forth, as well as distances between particular words and/or computed values or scores. Beneath the text is the assessment made, identifying in this instance particular brands and relevant text and proximity of such text. In this manner, the system determines options to offer the user, such as an image shown may be a Brand 1 dress, with highest Brand 1 priority, and/or brand 1 printed, lower priority, determined based on word proximity Proximity assessment 2 provides a second assessment performed by the system based on word proximity Proximity assessment 3 represents a user text conversation, again with proximity calculated based on distance between particular words. Again, this is tin the fashion/clothing realm, and Brand 1 may in non-fashion situations a different designator, such as Type 1 or Entity 1 or Classification 1.

Detected breaks or punctuation marks and computer generated characters represent a break or separation between one sentence and another. Breaks may include but are not limited to period, comma, semi-colon, colon, ‘|’ symbol, ‘/’ symbol, ‘\’ symbol, paragraph break, exclamation and question mark, shown as period 516, paragraph break 518, and comma 530 in FIGS. 5A, 5B, and 5C. When the system identifies text that is not a break, preposition keyword, product attribute keyword, or brand keyword, the system typically omits such text from query construction and use for word count to calculate distance between product attribute and brand keywords. Form the remaining words, the system determines a proximity score. Virtually any delineation between breaks and non-breaks may be employed, such as the letters j, k, and 1 being breaks and every other character as a non-break, as long as the system uniformly recognizes each character as a break or a non-break character. Once the system detects breaks from input text, proximity analysis module 322 is may calculate the proximity between brand keywords 502 and product category keywords 512, and may subsequently calculate proximity between product category keywords 512 and other product attribute keywords 510. Again, proximity is a numerical measure indicating the closeness or remoteness from product category keywords and other product attribute keywords. For example, for the product category “computer hardware,” a “processor” might have a proximity of 0.01, indicating closeness, while “feather” may have a proximity of 0.99, indicating remoteness. Numbers and values may change depending on desires and circumstances.

The following formulas may apply in the case where periods, semi-colons, paragraph breaks, ‘|’ symbol, ‘/’ symbol, exclamation and question marks are counted as breaks, such as period 516 and paragraph break 518. The system may calculate proximity from a product category keyword to a brand keyword within a break and yield a keyword rank or score expressed as:

$$\frac{Product category keyword count \#}{Total word count \# after or before brand keyword}$$

When a product category keyword 512 appears before the brand keyword, the count begins from the first word of the sentence until the nearest brand keyword 502 is reached. When the product category keyword 512 appears after the brand keyword, the count begins from the last word of the sentence until the nearest brand keyword 502 is reached.

Proximity is generally measured based on a distance in words between desired or known words. Proximities 506, 522, and 534 are shown.

As an example, a sentence may be received that says “Here's a Lexus we saw today on our trip up the coast—I think it is the new NX. I would love one of those!” The brand/type keyword in this situation would be “Lexus,” with the product category keyword being “NX.” In this example, the Product category keyword count # would be 1, as there is one category keyword, and the total word count # would be 16, as “NX” is 16 words away from “Lexus.”

Similarly, the system may use a mathematical formula to calculate proximity from a product attribute keyword, shown as keywords 510, 520, and 532, to a product category keyword 512 within a break and yield a keyword rank or score. This may be expressed as:

$$\frac{Product attribute keyword count \#}{Total word count \# after or before product category keyword}$$

When the product attribute keyword 510 appears before the product category keyword, the count begins from the first word of the sentence 516 until the nearest product category keyword 512 is reached. When the product attribute keyword 510 appears after the product category keyword, the count begins from the last word of the sentence until the nearest product category keyword 512 is reached.

For cases when a product category keyword appears within two breaks, such as period 516 and paragraph mark 518, and no brand keywords are present, the system employs an additional formula to further calculate proximity between product category keyword and nearest brand keyword, where the nearest brand keyword appears before a beginning break or after an ending break such as period 516, expressed as:

$$\frac{Product category keyword score}{4 n}$$

The system applies the formula above to the product category keyword score for each break (period 516, paragraph break 518) counted until the nearest brand keyword is reached 502. In the formula above, 4 is a coefficient and n may represent or be based on a total number of words in a sentence, paragraph, body of text and/or may employ or be a predetermined value.

Similarly, for cases where a product attribute keyword appears within two breaks and no product category keywords are present, the system introduces an additional formula to further calculate proximity between product attribute keyword and nearest product category keyword, where the nearest product category keyword appears before a beginning break or after a finishing break (period 516) and is expressed as:

$$\frac{Product attribute keyword score}{4 n}$$

The formula above is applied to the product attribute keyword score for each break counted (period 516, paragraph break 518) until the nearest product category keyword 512 is reached. In the formula above, 4 is again a coefficient and n may be a total number of words in a sentence, paragraph, body of text, or a value based on total number, and/or may be a predetermined value.

A slightly modified version of this formula is used for calculating proximity between product category keyword and brand keyword when commas, such as comma 530, are present. Commas are only counted as breaks when at least two brand keywords exist after or before a comma in a sentence. The word ‘and’ is also counted as a break when at least two brand keywords appear in a sentence with one brand keyword appearing after the word ‘and’ 514 in a sentence. The modified formula is introduced to further calculate proximity between product category keyword and brand keyword which is expressed as:

$$\frac{Product category keyword score}{2 n}$$

The formula above is applied to the product category keyword score for each comma 530 and ‘and’ word break 514 counted until the nearest brand keyword 502 is reached. The comma 530 that appears after the brand keyword is counted as a break while the preceding comma is not counted as a break unless a brand keyword is present. In the formula above, 2 is a coefficient and n may be based on or may be exactly the total number of words in a sentence, paragraph, body of text and/or a predetermined value.

FIG. 5B shows an alternate post, again with proximities determined and brands or types and keywords identified and correlated. FIG. 5C represents a conversation via SMS text message or otherwise between four users, and the system again seeks to assess brands/types and keyword proximities.

The system may use a slightly modified version of this formula to calculate proximity between product attribute keyword and product category keyword when commas, such as comma 530, are present. Commas are only counted as breaks when at least two brand keywords exist after or before a comma in a sentence. The system also counts the word ‘and’ as a break when at least two brand keywords appear in a sentence and at least one brand keyword appears after the word ‘and’ 514 in a sentence. The modified formula is introduced to further calculate proximity between product attribute keyword and product category keyword which is expressed as:

$$\frac{Product attribute keyword score}{2 n}$$

The formula above is applied to the product attribute keyword score 506 for each comma 530 and/or ‘and’ word break 514 counted until the nearest product category keyword 512 is reached. The comma 530 that appears after the product category keyword is counted as a break while the preceding comma is not counted as a break unless a product category keyword is present. In the formula above, 2 is a coefficient and n may be exactly or based on total number of words in a sentence, paragraph, body of text and/or a predetermined value.

The system may determine prepositions using a dictionary and may employ proximity analysis 322 to count preposition keywords (such as keyword “from” 504) that add more weight or increase the product category keyword proximity score with respect to a brand keyword. The system can perform such a calculation by adding the sum of product category keyword and preposition keyword proximity scores with respect to a brand keyword and taking an average of the two scores. The system may count preposition keywords if there is a 1:1 ratio of proximity between the product category keyword and the preposition keyword “from” 504. The system counts keywords if there is a positive effect on the product category keyword proximity score relative to the brand keyword 502.

The system calculates proximity from a preposition keyword 504 to a brand keyword 502 within a break and yields a keyword rank or score expressed as:

$$\frac{Preposition keyword count \#}{Total word count \# after or before brand keyword}$$

When the preposition keyword, such as keyword “from” 504 appears before the brand keyword, the count begins from the first word of the sentence until the nearest brand keyword 502 is reached. When the preposition keyword 504 appears after the brand keyword, the count begins from the last word of the sentence until the nearest brand keyword 502 is reached.

In the illustrated example, product category keyword ‘dress’ 512 yields a proximity score of 0.96 and preposition keyword ‘from’ 504 yields a proximity score of 1.0 relative to the brand keyword ‘Brand 1’ 502. The system calculates an average of the scores to yield a final proximity score of 0.98 for ‘dress’ to ‘Brand 1.’

In another configuration, preposition keywords 522 add more weight or increase the product attribute keyword proximity score with respect to a product category keyword 512. The calculation can be achieved by adding the sum of product attribute keyword and preposition keyword proximity scores with respect to a product category keyword and taking an average of the two scores. Preposition keywords are counted only if there is a 1:1 ratio of proximity between the product attribute keyword 520 and the preposition keyword 522. Furthermore, preposition keywords are only counted if there is a positive effect on the product attribute keyword proximity score relative to the product category keyword 512.

Similarly, the system calculates proximity from a preposition keyword 504 to a product category keyword 512 within a break and yields a keyword rank or score 506 expressed as:

$$\frac{Preposition keyword count \#}{Total word count \# after or before product category keyword}$$

When the preposition keyword (such as preposition “from” 504) appears before the product category keyword, the count begins from the first word of the sentence until the nearest product category keyword is reached 512. When the preposition keyword (e.g. “from” 504) appears after the product category keyword, the count begins from the last word of the sentence until the nearest product category keyword is reached 512.

In the illustrated example, product attribute keyword ‘canary’ 520 yields a proximity score of 0.77 and preposition keyword ‘color’ 522 yields a proximity score of 0.81 relative to the product category keyword ‘minidress.’ The system determines an average of the scores to yield a final proximity score of 0.81 for ‘canary’ to ‘minidress.’ Thus in FIG. 5A, certain information, such as “4^{th}” and “6^{th}” represent break numbers; others, such as “0.17” near the line joining “earrings” and “Brand 2” represent proximity calculation umber, superscripts such as “c” and “d” represent keyword classifications. “Yellow” “dress” “clutch” “jewelry” “gown” etc. represent “c” level or classification keywords, while words like “printed” “resort” and “flowing” represent “d” level or classification keywords.

Various configurations may be present in the read and listen module 122 to avoid errors in, for example, brand/type and product attribute keyword detection. Configurations to avoid such conflicts may omit a person's name, name of a location, and keywords with an alternative definition from the desired output. In the illustrated example, ‘Issa’ 508 is initially classified as a brand/type keyword but the system flags this word for a potential conflict based on previous information available. “Issa” 508 may be similar to other words or may be common enough to trigger a warning in certain circumstances. Proximity analysis may detect keywords sharing 1:1 proximity with a brand/type keyword or product attribute keywords to find conflicts. In the illustrated example, the embodiment identifies ‘Rae’ as a keyword of interest since it shares 1:1 proximity with ‘Issa’ 508 and starts with a capital letter, or in other words the system recognizes the words “Issa” and “Rae” used together, i.e. one word apart, represent a phrase that is known to the system as a brand/type based on past learning and/or training. The system may conduct further analysis to identify a second instance of ‘Rae’ 514 from the input text. The information analyzed therein may result in only one instance of brand/type keyword ‘Issa’ 508 from the input text with no product category keywords in winning (or close enough) proximity, but nevertheless sharing a 1:1 proximity with ‘Rae’ 514. In this instance, ‘Rae’ appears twice in the text, starts with a capital letter and is absent from any dictionary, index or database within the system. Therefore, the system may determine ‘Issa’ is not a brand/type keyword and may omit “Issa” alone from brand/type detection results 508. Learning component 328 may store “Issa Rae” in a dictionary of ‘person's names’ (not shown in FIGS. 5A, 5B, and 5C) that may be avoided in future brand/type detections 318.

Proximity assessment 2 includes Brand 1 with a proximity score of 1.0 relative to the word “coat” and 0.75 to the word “dress” and 0.38 to the word “hat.” The results of these assessments are shown below the words [query], representing a system query as to brands, in these examples, and relevant terms as determined by the system, in numerical order.

Proximity assessment 3 of FIG. 5C shows an alternate measure of proximity based on specific words, with an online text or chat assessed by the system. The system may be configured to format brand/type or product attribute keywords that may appear wrapped in computer generated symbols such as ‘@’, and ‘#’ which are prevalent in social media chat transcriptions. Brand keywords 538 where the ‘@’ symbol is present may be detected from an index of brand keywords when their respective social media accounts are found in a reference database. Users in social media may submit comments containing questions about products of interest in an image or scene. In the illustrated example, the universal formatting agent strips unwanted characters from a product attribute keyword ‘dress’ 532. Contextual analysis within the system identifies ‘dress’ as a product category keyword 532, followed by preposition keyword ‘from’ 534 and a question mark break 536. @user1 poses the ‘dress’ question to @user2, and @user2 responds to inquiry from @user1 in the chat timeline. The system omits or discards text that lacks reference to @user1 or @user2, not identified as a break, preposition keyword, product attribute keyword, or brand keyword from query construction. The system uses such text for word count, determining distance between product attribute and brand keywords to yield a proximity score. The system also omits text that lacks reference to @user1 or @user2 from query construction and such text may be used for word count to calculate distance between product attribute and brand keywords to yield a proximity score. An irrelevant comment 540 is also shown, having no weighting given.

Product category keywords and brand keywords with the highest proximity scores are paired. The system may pair attribute keywords and product category keywords with highest proximity scores. The system may construct a query for each highest scored pair of product category and brand keywords 528. The information retrieval module 120 may utilize the brand/type and product category keyword query to parse product data from a product merchant database 114. After the request is sent, the information retrieval module 120 may receive an array of products from the merchant database based on product category and brand/type keyword information. Products received by the information retrieval module 120 may be stored in a database and indexed according to brand/type, name, category, description, details, price, color, material, sizes, retailer and stock availability. The system may use the remaining product attribute keywords paired with the product category to rank each product in the database according to the number of matching attributes. Each matching attribute increments the overall score, such as incrementing by 1.

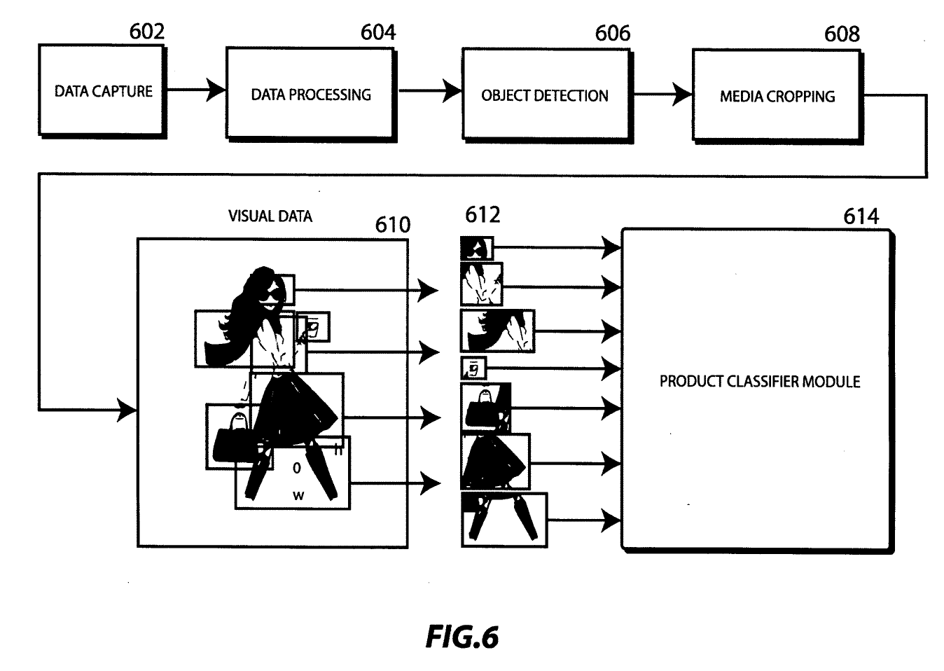

FIG. 6 illustrates the flow of visual data within the localize module 600. Localize module 600 may receive image or video data from the information retrieval or data capture module 602. The system may dissect video data captured into image frames to undergo further processing at point 604. The system may convert images received into different formats (jpeg, png, or gif) in advance of further processing. Object detection 606 analyzes the input image using shape, line and texture vectors to identify objects visible in the image. The center point for each object in the image may be assessed with resultant center point coordinates stored in a database. Using the calculated center-point coordinates, the object detection module draws a bounding box with specific width and height dimensions for each object within the image, with width and height either predetermined or based on circumstances. Color, shadow, and other visual detection may be employed to draw a box around a desired object in a received image.

Media cropping 608 separates the sub-portion of the image containing the object of interest and crops the respective region. This process is repeated for each object in the image, resulting in an array of cropped images or processed data 126, which may be transmitted to the product classifier module 614. In the illustrated example, a woman showcasing several products may be the subject of the image or visual data 610. Object detection identifies seven objects of interest and crops the image according to pre-determined width and height dimensions at point 612. The system may transmit the final output of cropped images to the product classifier module 614 which classifies objects according to their visible attributes. Thus a picture may be split and categorized into shirt, pants, shoes, handbag, etc.

FIG. 7 illustrates product category scoring, attribute scoring, and winning product scoring of an individual image from a series of related images in an example situation. As shown in the example, the system processes input image into a series of cropped images or sub-portions of the image, such as sub-image 702, each containing an object of interest. The system transmits cropped image 704 to the product classifier module 128. SKU classifier node begins to vote on each feature map within the cropped image. SKU classifier node may assign highest priority to “product category” in the scoring of a cropped image, and product category may be the first attribute considered. As shown in the example, the data set may contain image collections of ‘boots’ at the product category level, shown as elements 708, 712, and 714. The system calculates a confidence quotient from the input image that meets or exceeds a predetermined threshold indicating ‘boots’ class as the highest scored product category. In some embodiments, the system may assign multiple product categories to the input image based on a determined score that may meet or exceed a predetermined threshold, and scoring may be processed more than once. A series of image collections pertaining to each product attribute class may be provided in a product category image collection 716. Product attribute classes in the fashion situation may include but are not limited to color, material, name, description and details 710 for the garment or fashion item.

The attribute scoring module increases the score of the input image for each product attribute class having a value that meets or exceeds a predetermined threshold. The system calculates a final average of all highest scores for the input image considering product category and product attribute classes at point 706. In one example, the input image may receive a final score of 0.87 for ‘boot 1’, 0.67 for ‘boot 2’ and 0.58 for ‘boot 3,’ where boot 1, boot 2, and boot 3 are boot product categories and/or attribute classes. The system then employs winning-product processing, applying additional factors and determining an optimal product estimate for the input image 704, such as ‘boot 1, suede, black, over the knee, block heel, pointed toe’ (with a product score of 0.87).

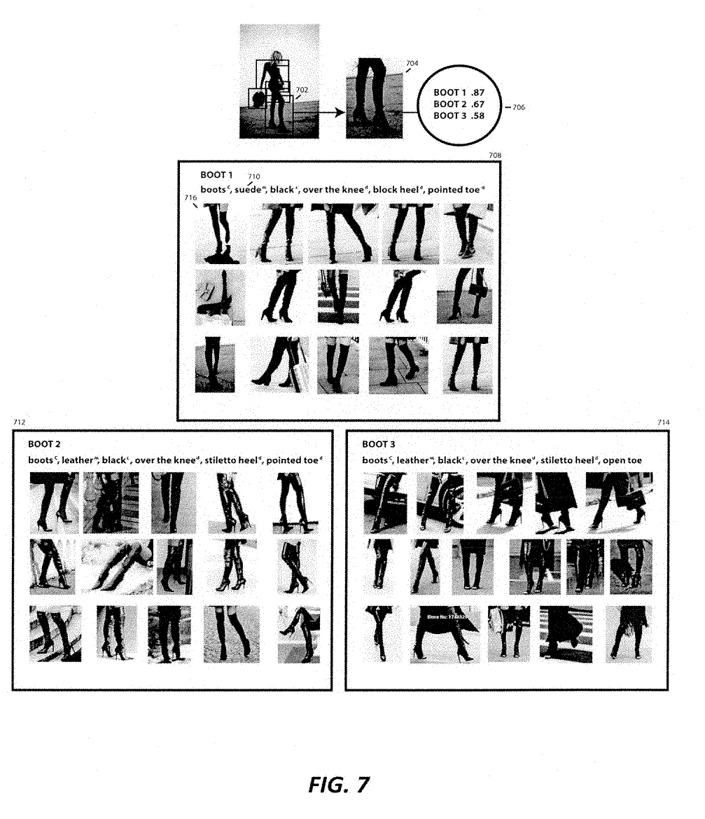

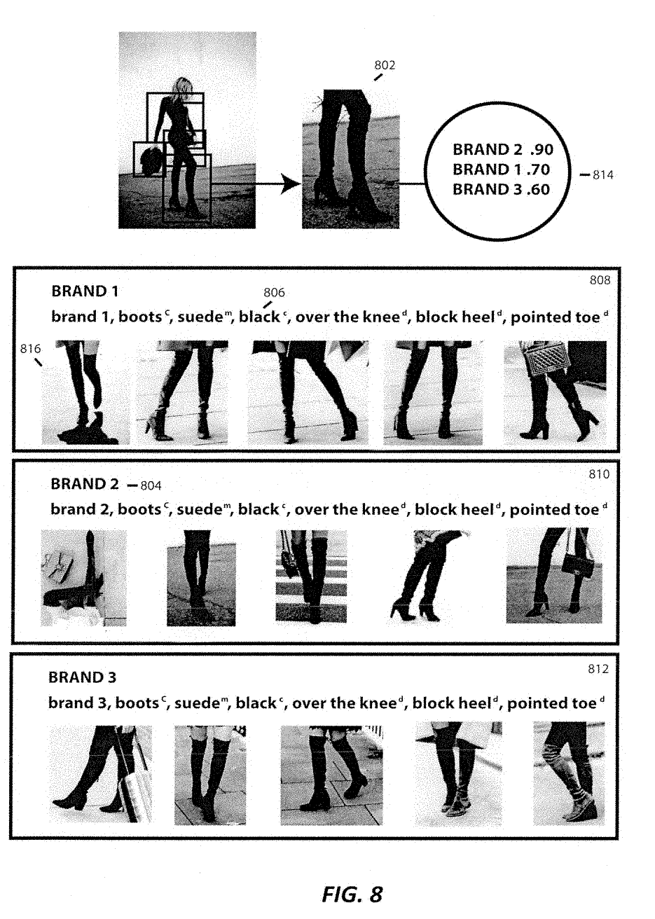

FIG. 8 illustrates an example of system brand/type scoring, product category scoring, attribute scoring, and winning product scoring of an individual image from a series of related images. In some cases, product classifier module may employ the brand/type classifier node to identify specific brand/type, manufacturer, designer or maker information of objects within the input image. The system may transmit cropped image 802 to the product classifier module. The brand/type classifier node may begin to vote on each feature map within the cropped image. The brand/type classifier node may assign first highest priority to brand/type information when calculating the score of a cropped image, therefore brand/type is the first consideration by the embodiment. The brand/type classifier node may assign second highest priority to product category when calculating the score of a cropped image, making “product category” a secondary consideration. As shown in the illustrated example, the data set contains image collections of ‘brand 1’, ‘brand 2’ and ‘brand 3’ at the highest consideration level, shown as elements 808, 810, and 812. The system calculates a confidence quotient from the input image that meets or exceeds a predetermined threshold indicating ‘brand 2’ class, shown as class 804, as the highest scored brand. The system may assign multiple brands to the input image based on score or scores that may meet or exceed a predetermined threshold or predetermined thresholds, and scoring may occur more than once. A series of image collections pertinent to each product category class may be provided within a brand image collection 816. Point 806 represents the categories or keywords associated with the brand and shown by the known representations presented, where image 816 represents an image known to conform to the brand and, in this situation, a boot, suede, black, over the knee, block heel, with pointed toe.

Category scoring by the system increases the score of the input image for each product category class within a brand/type classifier that meets or exceeds a predetermined threshold. The input image may have multiple product categories assigned based on scoring wherein determined scores may meet or exceed a predetermined threshold. Scoring may take place more than once. A series of image collections pertinent to each product attribute class may be provided within a product category image collection in association with the specific brand/type classifier. Product attribute classes in the fashion example may include but are not limited to color, material, name, description and details, shown as point 806, for each garment or fashion item. Attribute scoring may increase the score of the input image for each product attribute class within a brand/type classifier that meets or exceeds another predetermined threshold.

The system may then determine a final average of all highest scores for the input image considering (in the fashion realm) the brand/type, product category and product attribute classes at point 814. The system may determine scoring for the image such as a final score of 0.70 for ‘brand 1’, 0.90 for ‘brand 2’ and 0.60 for ‘brand 3.’ The system may apply additional factors and determine a “winning product” for the input image 802 as ‘brand 2, boots, suede, black, over the knee, block heel, pointed toe’ (product score of 0.90).

The system may employ or correlate known series of related images with previously-identified products to train the product classifier module, the brand/type scoring algorithm, the product category scoring algorithm, the attribute scoring algorithm, and/or the winning product algorithm. Training in this instance may entail comparing known attributes with existing images and improving the product category scoring, brand/type scoring, etc., such as by identifying different view angles of the item in question. The system may compare features within the image to known features of items, determine the image is a particular brand/type, has particular attributes, etc., and may assign the image to a known image database, thereby improving ability to determine associations between items and brands, products, etc.

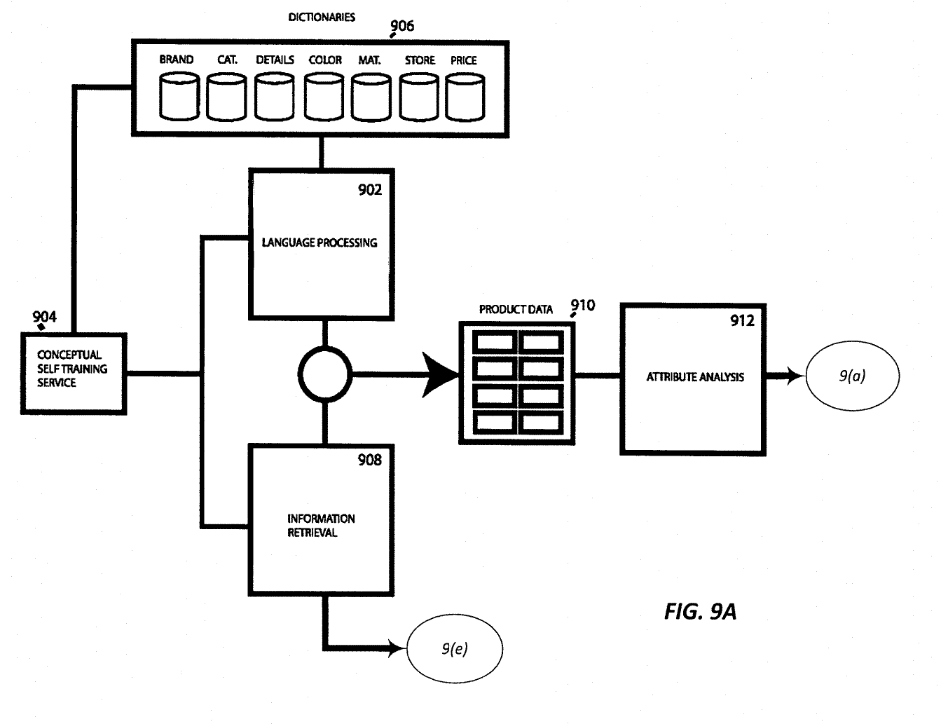

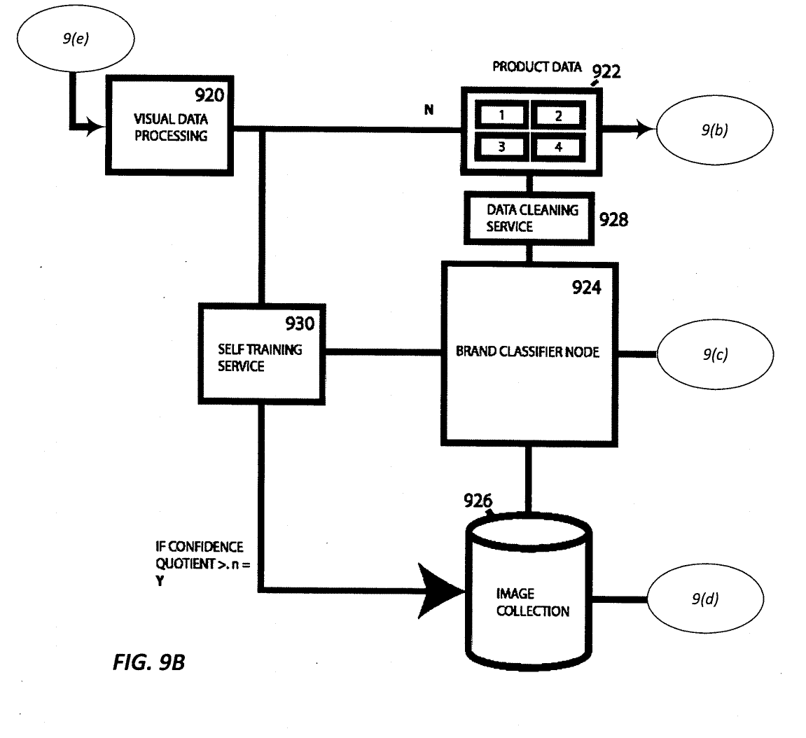

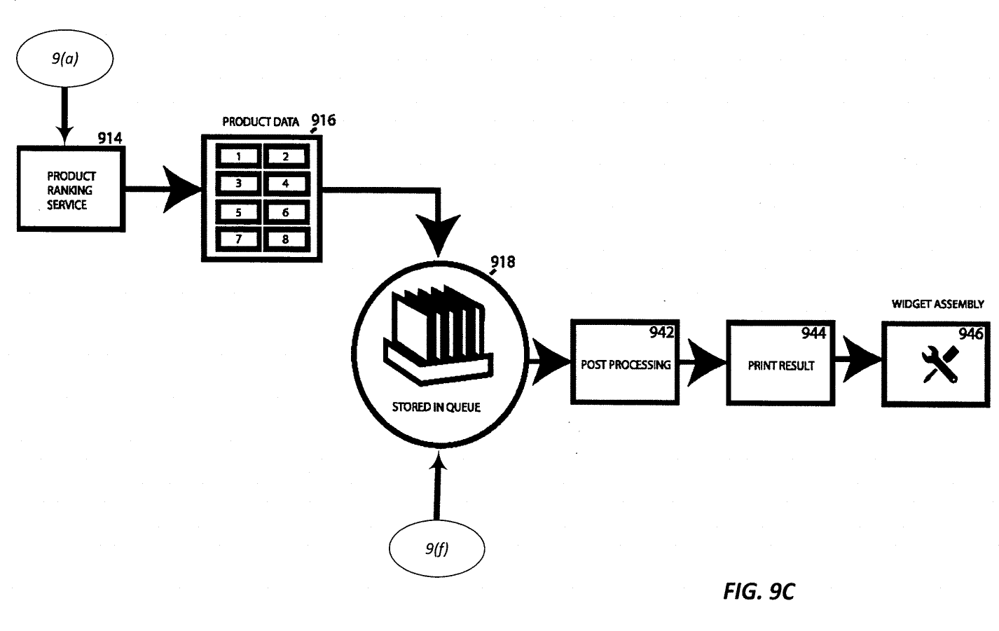

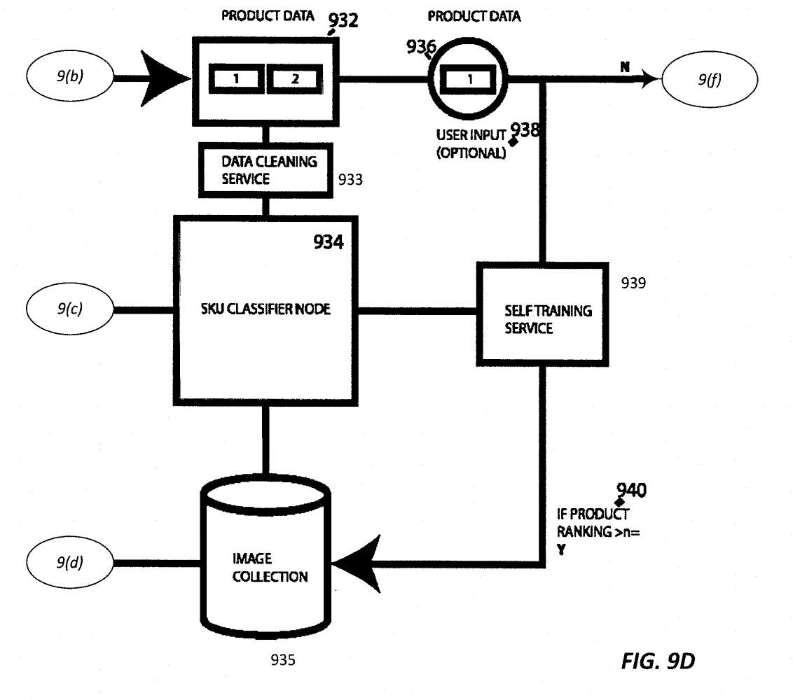

FIGS. 9A and 9B represent a data flow diagram that illustrates the components of the read and listen module and suggests the processing performed by the module, including information retrieval, localizing, product classifier, and learning modules. These modules determine and generate a final array of exact or visually similar products and provide an overview of the product ranking process according to the calculated output from product classifier module and language processing module at point 912. Language processing module 902 extracts relevant brand/type and product attribute keywords from the input text using dictionaries 906. Language processing module 902 may use a conceptual self training service module 904 for learning new language concepts and keywords for pairing that may improve language processing. The system constructs a query using the brand/type and product category keywords and transmits the query to information retrieval module 908. The information retrieval module parses product data from a product database, such as a merchant database, using the constructed query and stores the product data in array 910. The system uses product attribute keywords extracted from the input text to calculate a score for each matching attribute of products contained in the array.

Attribute analysis module 912 reads product attribute keywords from the input text and checks if the product attribute keywords match with values or keywords from, in the fashion situation, a product's name, color, material, description, details, sizes, price and/or retailer information within the data array. Each matching attribute increases the overall score of a product in array 914. Product ranking service sorts products in the array from highest to lowest scores according to the number of matching attributes 916. After sorting, the system stores products contained in the array in queue 918 while the system analyzes visual data.

The system, and specifically the localize module, processes visual data 920 into cropped images or sub portions of images or image frames containing objects of interest and transmits the objects of interest to brand/type classifier node 924. Brand/type classifier node 924 may, in the fashion example, classify each cropped image by brand/type, product category(s) and/or product attribute(s) when the input cropped images meet or exceed a predetermined confidence quotient required for one specific class. If the cropped image meets or exceeds a predetermined confidence value or quotient for a brand/type, product category or attribute class, self training module 930 may store the cropped image in an image collection 926 for each corresponding brand/type, product category and attribute class. In some embodiments, self training module 930 includes deep learning functionality to implement new attribute classes at the product category level, if the input cropped image meets or exceeds a predetermined score for attribute classes in product categories different from yet related to those assigned to a particular cropped image. In such cases, the system adds the new attribute class to a product category class. The system stores the cropped image in the corresponding image collection. In one example, the system classifies a cropped image as belonging to product category ‘boots’ and also classifies the cropped image as product attribute ‘stud, studded.’ However, in this example, ‘stud, studded’ product attribute exists only within the ‘sneakers’ product category image collection and not the ‘boots’ product category image collection. The self training module 930 operates to create a new class for product attribute ‘stud, studded’ within the ‘boots’ product category class and may train and/or store the cropped image in both classes.

After brand/type classifier node classifies the input cropped image, the system ranks product data stored in queue 918 according the number of matching brand/type, product category and attribute keyword and/or values. Each matching brand/type, product category or attribute keyword and/or value when compared to a product's brand, name, category, description, details, material(s), color(s) increases the overall score of a product at point 922. The system may employ a data cleaning module to remove products scoring below a predetermined rank threshold at point 928. The system sorts products in the array from highest to lowest scores according to the number of matching brands, product categories and attributes at point 922.

Brand/type classifier node and SKU classifier node may function to effectively “vote” on feature vectors contained in product images from a product data array. The system may record brand/type name(s), product category (or categories) and product attribute(s) having highest classification values for a particular product image. The system may record such brand/type name(s), product category (or categories) and product attribute(s) and/or store them in a database. The system may compare brand/type name(s), product category (or categories) and product attribute(s) with the input cropped image or image frame classification results, indicating the classification of images found within the cropped image or image frame. Products in the array may be ranked and sorted according to the number of matching brand/type name(s), product category (or categories) and product attribute(s) keywords and/or values when compared with the input cropped image or image frame.

If the system scores input cropped images at a value below the predetermined threshold required for brand/type classification, the system may transmit the cropped image to SKU classifier node 934. SKU classifier node 934 may classify product category and product attributes for the input cropped images. The SKU classifier node 934 may assign a product category and attribute label if the cropped image meets or exceeds a predetermined confidence quotient. In other words, if the product category is “automobile tire” and the predetermined value is 50%, if the system determines to a degree greater than 50% that the image includes an automobile tire, then it may assign the “automobile tire” product category to that image. Typically determining likelihood of product category with respect to an image comprises comparing the image to known images and assigning higher numbers to closer matches, for example. The system may employ the same procedure for attributes. After the SKU classifier node 934 classifies the cropped image, the system may employ data cleaning at point 933 and may rank product data in the array 932 according to the number of matching product category and attribute keywords or values. Each matching product category, attribute keyword, and/or value increases the overall score of a product, with score representing the likelihood that the image corresponds to the product category, attribute keyword, and/or value.

The system may employ data cleaning functionality to remove products with no matches or below a predetermined rank threshold. In other words, this image matches nothing we know of. If the cropped image meets or exceeds a predetermined rank for a product category or attribute class 940, the self training functionality provided in the system may store the cropped image in an image collection 926 for each corresponding product category and attribute class. Such a data cleaning function may terminate and the final product array may be provided to a user via a computer system or mobile device 936. A null result, or no result, may be provided, or if the system determines a result exceeding any predetermined threshold, the system may provide that result.

Product data received from module 936 may be provided to self training service 939, and if product ranking is above a certain level, to image collection 935, which may be separate from or combined with image collection 928.

In the fashion example, upon receiving a match or some quantifiable result or results, the user may employ his/her computing device to indicate a product is an exact match to an object within an image to address shortcomings of the recognition server 936. In other words, the user may indicate “that image is a 50 inch Samsung television” and thus may provide information usable by the system. A user may cause the system to add or remove products from the array if the data set presented is not an accurate reflection of objects visible in the image (“that is not a Microsoft mouse”). Such user input is transmitted back to the system, and the system may use these confirmations or denials to increase or decrease product ranking, brand/type scoring, category scoring, attribute scoring and/or winning-product scoring to existing or new products in the data array. The system's self training functionality may utilize received user input to train and store cropped images in a particular brand/type, product category and/or attribute class, thus improving the accuracy of brand/type and SKU classifier nodes. It must be realized that some users may provide false positives, or may be mistaken, or may wish to undermine system functionality, and such user indications may or may not be used depending on system preferences and functionality.

After the system receives user input, the system may again sort products from highest to lowest scores. The system may store the final array in a queue 918. The system may employ post processing functionality 942 to format product data results in various desired output formats, including but not limited to JSON, XML, CSV, and TXT. The system or user may print or otherwise provide results in a executable format that may be called, received, and/or or utilized by other computer systems, mobile devices, publisher websites, merchant websites, smart televisions, virtual reality headsets, augmented reality environments and/or any type of computing device. Printed results 944 of the final product data array in the fashion example may include product information not limited to brand/type, designer and/or maker, name, price, images, description, details, sizes available, price information, stock availability, retailer/carrier information, color(s), and material(s). Pint 946 represents a widget assembly function.

Using the printed results, a computing device may assemble a widget or image tag with HTML, CSS and Javascript elements, and may display images of products and product information of the highest ranked product array. In one food example, a user may capture video and text data from a food blog and transmit the video and text data to the system, such as a recognition server, facilitated by an API or website plugin. The system may print final product array results and assemble an ‘action’ widget with final product data. The system may transmit the printed results back the food blog URL containing the original food video and text data. The ‘action’ widget, which may take the form of a “shop” widget or other appropriate widget based on the actions available to the user, may appear in the form of a product list, image tag, shop button or in-video shopping assistant providing users the option to take an action, such as buy or view more information about exact or very similar food products in the scene. In some embodiments, the system may embed, caption, annotate, or integrate the widget with the visual data and may display one or more of such representations to the user.

Methods and actions illustrated in FIGS. 9A and 9B may be performed using the system, such as that shown in FIG. 2. Certain methods, such as methods illustrated in FIGS. 5 and 6, may be performed using a mobile device.

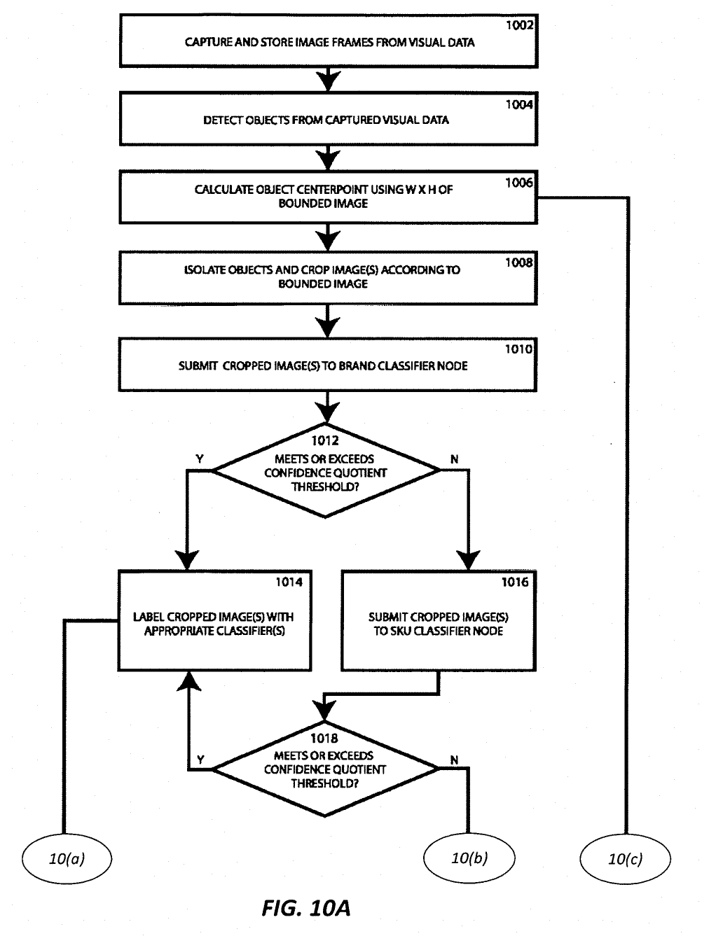

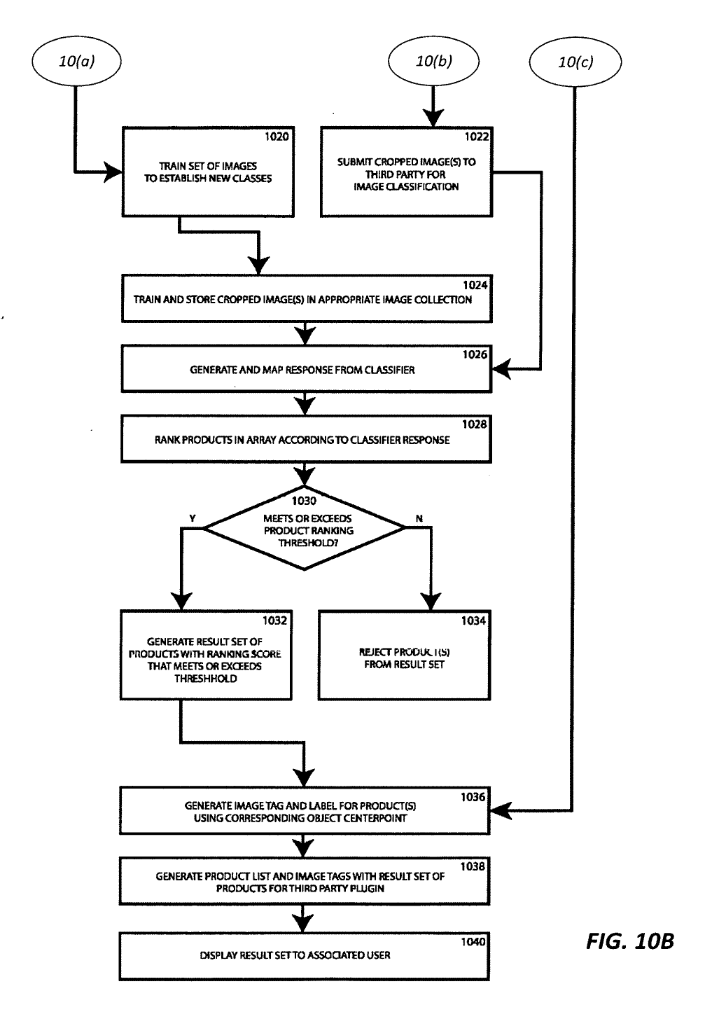

FIGS. 10A and 10B illustrate an example of a method utilizing the system to perform branded product recognition of objects within a video clip or image provided by a publisher, or media network, using localize and product classifier modules. The system extracts, or a user uploads, images and/or image frames from a data feed. The system may store uploaded images in database at point 1002. The system may detect objects of interest within the image and may store coordinates in a database at point 1004, such as center point coordinates or borders. The system may use object width and height coordinates and calculate the center point of the object, and may provide or draw a bounding box or sub-portion of the image containing the object of interest at point 1006. The system may crop or isolate the bounding box or sub-portion of the image containing the object of interest for further inspection 1008. In the fashion example, the system may transmit a cropped image or images to the brand/type classifier node to undergo brand/type, product category(s) and product attribute(s) classification 1010. If the system determines the cropped image(s) meets or exceeds a predetermined confidence quotient threshold 1012, the system labels the cropped image(s) with the appropriate brand/type, product category(s), and/or product attribute(s) classes 1014. However, if the system determines the cropped image(s) is below a predetermined confidence quotient threshold 1012 for the brand/type classifier node, the system may transmit the cropped image or images to the SKU classifier node to undergo product category(s) and product attribute(s) classification 1016. If the system determines the cropped image(s) meet or exceed a predetermined confidence quotient threshold 1018 for SKU classifier node, the system may label the cropped image(s) with the appropriate product category(s), and product attribute(s) class 1014.

Alternately, if the system determines the cropped image(s) score is below a predetermined confidence quotient threshold 1018 at the SKU classifier node, the system may transmit the cropped image(s) to a third party computer vision solution using a network, application programming interface (APIs), website or other medium to generate and receive an image classification label for the cropped image(s) 1022. The system processes the label received using a language model to detect relevant product information such as, in the case of fashion, brand(s), product category(s) and product attribute(s) keywords and/or values 1026.

The system may use cropped image(s) to train data and establish new classes in brand/type and/or SKU classifier node(s) 1020. A system may store cropped image(s) in an appropriate image collection corresponding to, in the fashion realm, a brand/type, product category(s) or product attribute(s) class where the score of the cropped image(s) met or exceeded a predetermined confidence quotient threshold 1024. For example, if the threshold is 80% and the system compares the image to an image of a hot dog, and the image is determined to be more than 80% likely to be a hot dog based on comparisons with other hot dog images, the image is stored as a hot dog image. After the system labels cropped image(s) with appropriate classes, the system records the label and may store the image and/or the label in a database 1026. Products may be ranked, in a database, according to the number of matching values or keywords corresponding to a cropped image(s) brand/type, product category(s) and/or product attribute(s) classification 1028 in the fashion situation. Products that meet or exceed a predetermined product rank threshold 1030 may be stored in a final array at point 1032. Products that are below a predetermined product rank threshold may be rejected from the final array at point 1034. Using the stored center-point or coordinates of the cropped image(s) 1006, the system may generate an image tag and annotate the original image or image frame with highest ranked product information. In the fashion example, such product information may include but is not limited to information such as brand(s), name(s), category(s), price, description, details, color(s), material(s), product URL, retailer or carriers, size availability and/or stock availability at point 1036.

The system may generate a product list or widget that contains product information of the final product array at point 1038. The system may display final product array, product list, widget and/or image tag(s), and/or may transmit these items to a user using an application programming interface (API), network, mobile device, computing device and/or website application at point 1038. At point 1040, the system displays the result set to the user.

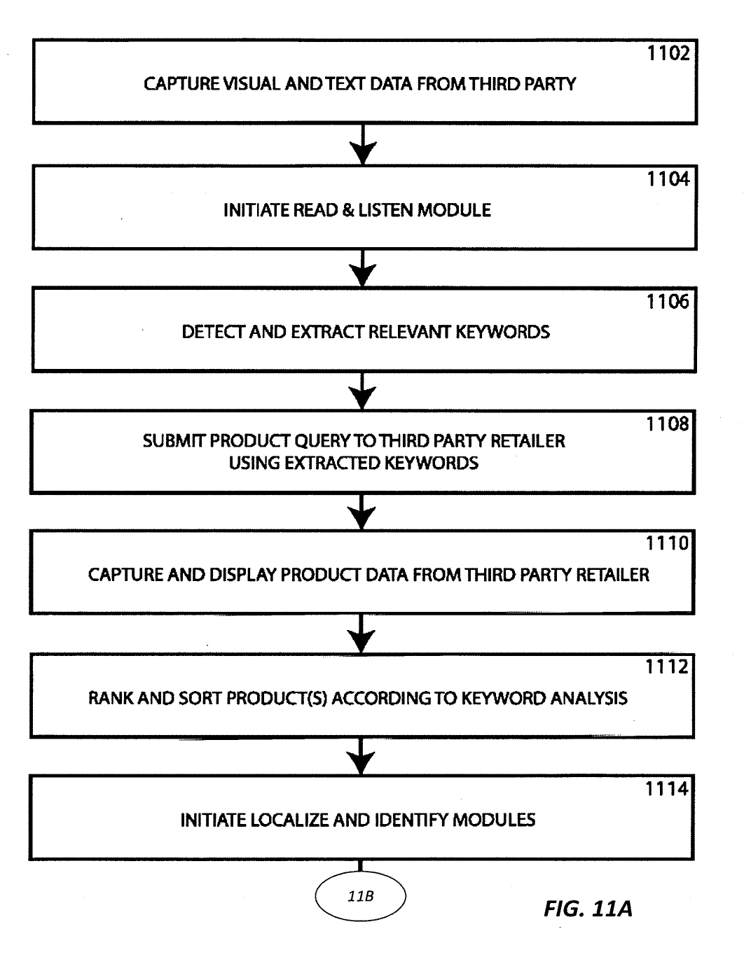

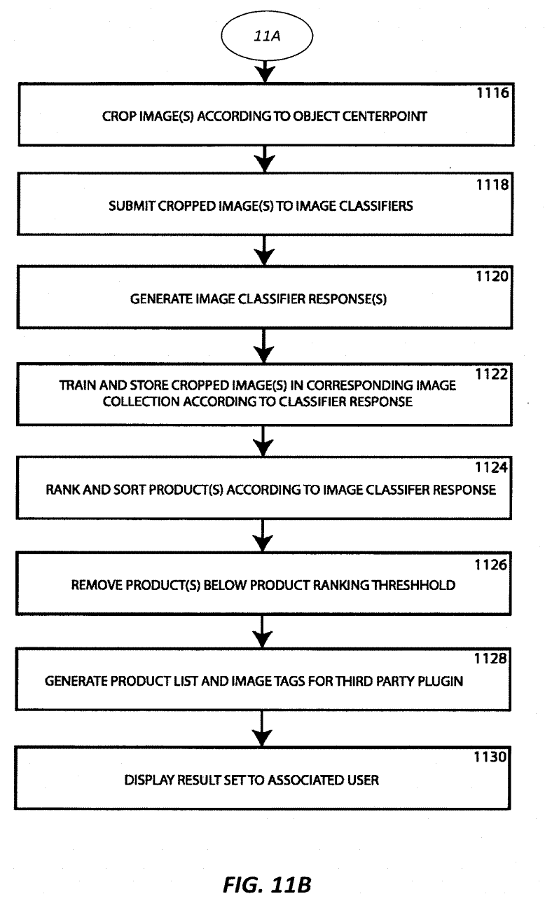

FIGS. 11A and 11B represent a flowchart that provides an overview of the processes performed by an automated visual product recognition system 1100. The system captures or receives visual and/or text data from a third party 1102. In an example embodiment, the third party may include a user uploading images stored on a mobile device, or alternately the owner and/or operator of a mobile application and/or website. The read and listen module 1104 receives input text and subsequently detects and extracts, in the fashion situation, relevant brand/type, product category(s) and product attribute(s) keywords from the received input text at point 1106. The system constructs a query using only the brand/type and product category keywords. The system submits a constructed query to a third party retailer or merchant database 1108. A server receives product data from the third party and stores products, in the fashion example, according to brand/type, name(s), product image(s), category(s), description, details, price, size availability, inventory availability, color(s), material(s), retailer and/or carrier information. The system may retrieve product data and may display the product data using an interface that interacts with another server or a third-party service configured to perform such retrieval and/or display functions at point 1110. The system may rank products in the array according to the remaining keywords extracted from the input text that may or may not be related to, in the fashion example, brand/type, product category(s) and/or product attribute(s) at point 1112.

The system may retrieve visual data from data storage and may transmit such data to localize and product classifier modules 1114. The system processes visual data into executable images and/or image frames. The system may include object detection algorithms configured to detect objects of interest within an image, calculate their center-point coordinates, and crop the sub-portion or bounded region of the image where the object exists as shown at point 1116. The system may submit cropped images of objects image classifiers which include but are not limited to brand/type and SKU classifier nodes 1118 embodied within a neural network. Image classifiers generate a label for a cropped image(s) brand/type, product category(s) and/or product attribute(s). The system generates image classifier responses at point 1120. The system may crop image(s) and may store such cropped image(s) or train the system to reinforce existing classes and/or create, remove, or re-arrange new classes of images at point 1122. The system may rank products in the array and may sort such images according to the results of a matching algorithm which may consider brand/type, product category(s) and/or product attribute(s) 1124 in the fashion example. The system may remove products ranked below a predetermined threshold from the final array at point 1126. The system may reproduce a list of products in the final array using a graphical user interface (GUI) in the form of image tag(s), widget(s) and/or a commerce or shopping application 1128. The system may transmit a final list of products using a third-party application, application programming interface (API), network, server and/or third-party plugin and displayed to users at point 1130.

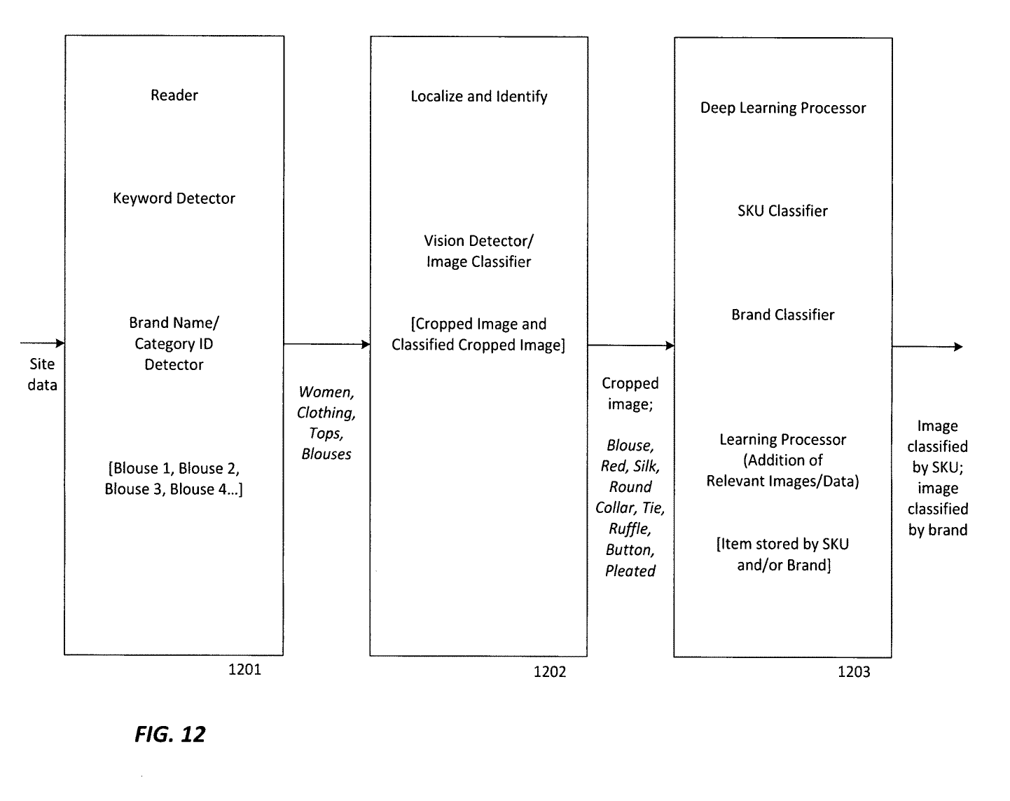

FIG. 12 is a top level representation of an alternate concept of the present design. From FIG. 12, the system comprises a reader apparatus 1201, a localize and identify apparatus 1202, and a deep learning processor apparatus 1203. The reader apparatus 1201 receives information from a user or web site and processes the information received by perofrming language processing and performs a web crawling operation. As with other examples presented herein, FIG. 12 is directed to the fashion arena. Reader apparatus 1201 thus receives information, such as web site information, and detects keywors, @mentions, #hashtags, and so forth associated with images provided. In one instance, the term “blouse” may be associated with the image, and a brand/type name, such as “Kors” may also be associated with the image. Based on the information gleaned by the reader apparatus 1201, applicable information about the visual representation may be transmitted, including a list of candidate blouses (blouse 1, blouse 2, blouse 3, etc.), as well as applicable categories for the visual representation (clothing, womens, top, blouse, etc.) Localize and identify apparatus 1202 receives the information and performs vision functionality, such as localizing the representation, specifically trimming the representation to only include products of interest in the representation, such as by cropping, and identifying attributes from the visual representation so cropped. For example, once cropped, the localize and identify apparatus 1202 may determine attributes such as buttons, type of sleeve, type of collar, material, color, and so forth. Localize and identify apparatus, as discussed herein, visually processes based on known and/or expected attributes of a product. The result is a cropped image and particular, focused attributes. These are passed to deep learning processor 1203, which may perform SKU classification, classifying the representation as a particular SKU for a specific known product, and/or classifying the visual representation by the appropriate brand/type name This information may be stored, and learning may occur as described herein, i.e. adding a visual representation of a red Gucci blouse to the collection of known red Gucci blouses. Again, during any of this processing, the image and information may be provided to the user to determine whether he/she agrees with the assessment, i.e. that this is a red Gucci blouse that corresponds to product SKU XXX. The result is an offering of the desired product or products to the user from a particular entity. Firestone tire 85SR13 may be available from entity 1, entity 2, or entity 3, and relevant information provided to the user by the system.

The following represent alternate proximity calculations performed by the system, wherein such alternate proximity calculations may be used in the general situation when seeking to match text with visual representations or portions of visual representations.

A determination is made based on proximity by pairing a category with a brand or type. If the category is presented before a brand or type, such as “a shovel from Home Depot . . . ” the system determines proximity based on the calculation:

(P_category(inclusive)−P_previousbreak)/(P_brand(exclusive)−P_previousbreak)

In the case of “shovel from Home Depot,” proximity is (4 minus 0) over (6 minus zero), or 0.6666.

If, on the other hand, the brand or type is recited before the category, such as “Home Depot shovel,” proximity is:

(P_nextbreak−P_category(inclusive))/(P_nextbreak−P_brand(exclusive))

In this case, proximity is (6 minus 5)/(6 minus 5), or 1.000.

In some instances, the category is paired with a material, color, or type, whereby the material, color, or type replaces “brand” in the proximity determinations presented above. Virtually any type of qualifier or categorization can be employed and assessed, and the system is not limited to determining brand, material, color, or type in a visual or text representation.

With respect to breaks, a comma’,’, ‘and’ represent breaks. In one embodiment, only ‘,’ and ‘and’ between brand or brand type designator and another word, such as the product type, can be treated as special break. A normal break may be characters such as ? (question mark). <p> (page break); ! (exclamation point) or / (forward slash). Special breaks are typically used when there are multiple brands and product types being described in one sentence. For example, when the system detects, in the fashion scenario, ‘Balenciaga shoes, dress by Forever 21, and handbag from Chloe.’ Each comma and the word ‘and’ is treated by the system as a break to separate the final values: (1) ‘Brand: Balenciaga Category: Women>Shoes,’ (2) ‘Brand: Forever 21 Category: Women>Clothing>Dresses’ and (3) ‘Brand: Chloe Category: Women>Bags>Handbags’

Pair rules include, for each category, the system calculating all proximities of brand. The system pairs category with brand with the highest proximity if the proximity is greater than a given threshold value, in one instance 0.0053. The system may do similar pairing with color and material, with a different threshold, such as 0.25.

If there are breaks between category and target (brand, color, material), the system divides the proximity will be divided by a decade factor for each break (4 for special break, 8 for normal break.)

Thus, according to one aspect of the present design, there is provided a classification apparatus, comprising a reader apparatus configured to receive visual information and textual information associated with the visual information and detect query relevant categorization information regarding products or service of interest to a user from the visual information and textual information associated with the visual information, a localize and identify apparatus configured to receive the visual information and the query relevant categorization information and selectively reduce the visual information to a relevant visual representation and detect further categorization information based on the relevant visual representation, and a deep learning processor apparatus comprising a unit classifier and a brand classifier, wherein the unit classifier correlates the relevant visual representation with a specific product identification code, and the brand classifier correlates the relevant visual representation with a brand considered represented in the relevant visual representation.

According to a further aspect of the present design, there is provided a method for classifying items using a classification apparatus. The method comprises receiving visual information and textual information associated with the visual information, detecting query relevant categorization information regarding products or service of interest to a user from the visual information and textual information associated with the visual information, receiving the visual information and the query relevant categorization information and selectively reduce the visual information to a relevant visual representation, detecting further categorization information based on the relevant visual representation, correlating the relevant visual representation with a specific product identification code, and correlating the relevant visual representation with a brand considered represented in the relevant visual representation.

According to another aspect of the current design, there is provided a classification apparatus comprising reader means for reading information provided, wherein the reader means are configured to receive visual information and textual information associated with the visual information and detect query relevant categorization information regarding products or service of interest to a user from the visual information and textual information associated with the visual information, localize and identify means for visually identifying information, wherein the localize and identify means are configured to receive the visual information and the query relevant categorization information and selectively reduce the visual information to a relevant visual representation and detect further categorization information based on the relevant visual representation, and deep learning processor means for establishing additional information related to the visual information, wherein the deep learning processor means are configured to correlate the relevant visual representation with a specific product identification code and correlate the relevant visual representation with a brand considered represented in the relevant visual representation.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, although the foregoing embodiments have been described in the context of a social network system, it will apparent to one of ordinary skill in the art that the invention may be used with any electronic social network service and, even if it is not provided through a website. Any computer-based system that provides social networking functionality can be used in accordance with the present invention even if it relies, for example, on e-mail, instant messaging or other form of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a social network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A classification apparatus, comprising:
a reader apparatus configured to receive visual information and textual information associated with the visual information and detect query relevant categorization information regarding products or service of interest to a user from the visual information and textual information associated with the visual information;
a localize and identify apparatus configured to:
receive the visual information and the query relevant categorization information and selectively reduce the visual information to a relevant visual representation; and
detect further categorization information based on the relevant visual representation; and
a deep learning processor apparatus comprising a unit classifier and a type classifier, wherein the unit classifier correlates the relevant visual representation with a specific product identification code, and the type classifier correlates the relevant visual representation with a type considered represented in the relevant visual representation.

2. The classification apparatus of claim 1, wherein the deep learning processor apparatus adds the relevant visual representation with at least one type considered to be represented in the relevant visual representation, the further classification information, and the specific product identification code to known visual representations.

3. The classification apparatus of claim 1, wherein the classification apparatus is configured to report at least one type considered to be represented in the relevant visual representation, the further classification information, and the specific product identification code to the user.

4. The classification apparatus of claim 3, wherein the user has identified the visual information to the classification apparatus.

5. The classification apparatus of claim 1, wherein the relevant visual representation comprises a single physical item, and wherein the classification information comprises information pertaining to the single physical item.

6. The classification apparatus of claim 1, wherein the localize and identify apparatus is configured to compare the relevant visual representation to known visual representations of similar products and score similarity between the relevant visual representation and the known visual representations of similar products.

7. The classification apparatus of claim 1, wherein the classification apparatus classifies various fashion related items.

8. A method for classifying items using a classification apparatus, comprising:
receiving visual information and textual information associated with the visual information;
detecting query relevant categorization information regarding products or service of interest to a user from the visual information and textual information associated with the visual information;
receiving the visual information and the query relevant categorization information and selectively reduce the visual information to a relevant visual representation;
detecting further categorization information based on the relevant visual representation;
correlating the relevant visual representation with a specific product identification code; and
correlating the relevant visual representation with a type considered represented in the relevant visual representation.

9. The method of claim 8, further comprising adding the relevant visual representation with at least one type considered to be represented in the relevant visual representation, the further classification information, and the specific product identification code to known visual representations.

10. The method of claim 8, further comprising reporting at least one type considered to be represented in the relevant visual representation, the further classification information, and the specific product identification code to the user.

11. The method of claim 10, wherein the user has identified the visual information to the classification apparatus.

12. The method of claim 8, wherein the relevant visual representation comprises a single physical item, and wherein the classification information comprises information pertaining to the single physical item.

13. The method of claim 8, further comprising:
comparing the relevant visual representation to known visual representations of similar products; and
scoring similarity between the relevant visual representation and the known visual representations of similar products.

14. The method of claim 8, wherein the classification apparatus classifies various fashion related items.

15. A classification apparatus, comprising:
reader means for reading information provided, wherein the reader means are configured to receive visual information and textual information associated with the visual information and detect query relevant categorization information regarding products or service of interest to a user from the visual information and textual information associated with the visual information;
localize and identify means for visually identifying information, wherein the localize and identify means are configured to:
receive the visual information and the query relevant categorization information and selectively reduce the visual information to a relevant visual representation; and
detect further categorization information based on the relevant visual representation; and
deep learning processor means for establishing additional information related to the visual information, wherein the deep learning processor means are configured to correlate the relevant visual representation with a specific product identification code and correlate the relevant visual representation with a type considered represented in the relevant visual representation.

16. The classification apparatus of claim 15, wherein the deep learning processor means is configured to add the relevant visual representation with at least one type considered to be represented in the relevant visual representation, the further classification information, and the specific product identification code to known visual representations.

17. The classification apparatus of claim 15, wherein the classification apparatus is configured to report at least one type considered to be represented in the relevant visual representation, the further classification information, and the specific product identification code to the user.

18. The classification apparatus of claim 17, wherein the user has identified the visual information to the classification apparatus.

19. The classification apparatus of claim 15, wherein the relevant visual representation comprises a single physical item, and wherein the classification information comprises information pertaining to the single physical item.

20. The classification apparatus of claim 15, wherein the localize and identify means is configured to compare the relevant visual representation to known visual representations of similar products and score similarity between the relevant visual representation and the known visual representations of similar products.

21. The classification apparatus of claim 15, wherein the classification apparatus classifies various fashion related items.
